(19) United States
(12) Patent Application Publication
(10) Pub. No.: US 2019/0171588 A1
(43) Pub. Date: Jun. 6, 2019

(54) MULTI-POINT VIRTUAL GENERAL-PURPOSE INPUT/OUTPUT (MP-VGI) FOR LOW LATENCY EVENT MESSAGING

(71) Applicant: QUALCOMM Incorporated, San Diego, CA (US)

(72) Inventors: Lalan Jee MISHRA, San Diego, CA (US); Richard Dominic WIETFELDT, San Diego, CA (US)

(21) Appl. No.: 16/162,508

(22) Filed: Oct. 17, 2018

Related U.S. Application Data
(60) Provisional application No. 62/594,967, filed on Dec. 5, 2017.

(51) Int. Cl. G06F 13/10; G06F 13/42; G06F 13/38; H04B 1/40; G06F 9/455

(52) U.S. Cl. CPC G06F 13/105; G06F 13/4282; G06F 2009/45579; H04B 1/40; G06F 9/45558; G06F 13/387

(57) ABSTRACT

Systems, methods, and apparatus adapted to transmit coexistence management interface (CxMi) messages over a multi-point serial bus are described. A method performed at a device coupled to a multi-point serial bus includes encoding CxMi state as one or more virtual general-purpose input/output (VGI) messages, and transmitting the VGI messages over the multi-point serial bus in a command code field of a datagram addressed to one or more devices coupled to the multi-point serial bus. The serial bus may be operated in accordance with an RFFE protocol SPMI protocol.

### PRIORITY CLAIM

This application claims priority to and the benefit of U.S. Provisional Patent Application Ser. No. 62/594,967 filed in the U.S. Patent Office on Dec. 5, 2017, the entire content of this application being incorporated herein by reference as if fully set forth below in its entirety and for all applicable purposes.

### TECHNICAL FIELD

The present disclosure relates generally to serial communication over a shared serial bus and, more particularly, to optimizing latencies associated with the shared serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, such as a multi-drop serial bus or a parallel bus. General-purpose serial interfaces are known in the industry, including the Inter-Integrated Circuit (I2C or I²C) serial bus and its derivatives and alternatives. Certain serial interface standards and protocols are defined by the Mobile Industry Processor Interface (MIPI) Alliance, including the I3C, system power management interface (SPMI), and the Radio Frequency Front-End (RFFE) interface standards and protocols.

The RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links. SPMI standards and protocols provide a hardware interface that may be implemented between baseband or application processors and peripheral components. In some implementations, the SPMI is deployed to support power management operations within a device.

In many instances, a multi-drop serial interface may be provided to support high-priority, low-latency communication between an application processor and certain peripherals, and other lower-priority communication. Latency can be adversely affected when multiple devices coupled to the serial bus are concurrently active. Degraded latencies can lead to an increase in dropped packets, session timeouts and retransmissions on the serial bus. Latency can prevent the use of a serial bus for some low-latency applications such as real-time signaling and control, and additional communication links may be employed to handle real-time communications at the cost of increased physical input/output pins, connectors and wires. As mobile communication devices continue to provide greater levels of functionality, improved serial communication techniques are needed to improve latencies and/or handling of priority traffic on a serial bus that couples peripherals and application processors with a reduced number of physical connections.

### SUMMARY

Certain aspects of the disclosure relate to systems, apparatus, methods and techniques communicating coexistence management interface (CxMi) messages over a multi-point serial bus as multi-point general-purpose input/output (MP-VGI) messages.

In various aspects of the disclosure, a method performed at a device coupled to a multi-point serial bus includes encoding CxMi state information in a virtual general-purpose input/output (VGI) message, and transmitting the VGI message over the multi-point serial bus in a command code field of a datagram addressed to one or more devices coupled to the multi-point serial bus.

In one aspect, the multi-point serial bus is operated in accordance with an RFFE protocol or an SPMI protocol. In one aspect, the one or more devices maintain at least one register that is configured to cause a bus interface of the one or more devices to identify that the command code field carries the VGI message. The method may include configuring a first bit of the command code field to have a value indicating that the command code field carries a Register 0 write command.

In some aspects, the method may include increasing size of the command code field, wherein one or more additional bits added to the command code field are used to carry a portion of the VGI message. At least one device may maintain a configuration register that identifies the size of the command code field and that enables or disables processing of the command code field as a VGI message by a corresponding device.

In certain aspects, the method includes addressing the datagram to a magic address configured to identify that the datagram carries a VGI message. Each of the one or more devices may maintain a configuration register that identifies the magic address and that enables or disables processing of the command code field as a VGI message by a corresponding device. The magic address may be transmitted in a slave address field of the datagram in accordance with an SPMI or RFFE protocol.

In one aspect, the one or more devices identify a sending slave address by capturing the sending slave address of a slave device that wins an arbitration. In one aspect, the method includes formatting the CxMi state information as a WCI-2 message in the VGI message.

In various aspects of the disclosure, a data communication apparatus has a processor and a bus interface configured to couple the apparatus to a multi-point serial bus. The processor may be configured to encode CxMi state information in a VGI message, provide the VGI message in a command code field of a datagram addressed to one or more devices coupled to the multi-point serial bus, and cause the bus interface to transmit the datagram over the multi-point serial bus.

In various aspects of the disclosure, a transitory or non-transitory processor-readable storage medium may have one or more instructions which, when executed by at least one processor or state machine of a processing circuit, cause the processing circuit to encode CxMi state information in a VGI message, and transmit the VGI message over the multi-point serial bus in a command code field of a datagram addressed to one or more devices coupled to the multi-point serial bus.

In various aspects of the disclosure, an apparatus operable for communicating CxMi information over a multi-point serial bus includes means for encoding CxMi state information in a VGI message, and means for transmitting the VGI message over the multi-point serial bus in a command code field of a datagram addressed to one or more devices coupled to the multi-point serial bus.

### BRIEF DESCRIPTION OF THE DRAWINGS

FIG. 1 illustrates certain aspects of a system 100 adapted to support coexistence management functions.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an SPMI bus to couple various devices in accordance with certain aspects disclosed herein.

FIG. 5 illustrates an apparatus that includes an application processor coupled to multiple peripheral devices.

FIG. 6 illustrates an apparatus that uses multi-drop, serial bus to couple various devices in accordance with certain aspects disclosed herein.

FIG. 7 illustrates an example of a conventional CxMi implementation.

FIG. 8 illustrates an example of a system adapted to transport CxMi messages within defined time constraints.

FIG. 9 illustrates datagram structures for Register-0 Write command in accordance with SPMI and RFFE protocols.

FIG. 10 illustrates first examples of datagrams for SPMI-based MP-VGI in accordance with certain aspects disclosed herein.

FIG. 11 illustrates second examples of datagrams for RFFE-based MP-VGI in accordance with certain aspects disclosed herein.

FIG. 12 illustrates third examples of datagrams for SPMI-based MP-VGI and RFFE-based MP-VGI in accordance with certain aspects disclosed herein.

FIGS. 13 and 14 illustrate datagrams that support multi-radio coexistence management in accordance with certain aspects disclosed herein.

FIG. 15 illustrates transportation of Radio-ID parameters using MP-VGI Mode-B in accordance with certain aspects disclosed herein.

FIG. 16 illustrates a system that includes one or more devices that may be adapted to support MP-VGI for CxMi accordance with certain aspects disclosed herein.

FIG. 17 illustrates selection between WCI-2 UART and MP-VGI interfaces in accordance with certain aspects disclosed herein.

FIG. 18 provides a comparison of UART transmission latency components and SPMI transmission latency components.

FIG. 19 provides a comparison of UART transmission latency components and RFFE transmission latency components.

FIG. 20 illustrates one example of an apparatus employing a processing circuit that may be adapted according to certain aspects disclosed herein.

FIG. 21 is a flowchart that illustrates certain aspects disclosed herein.

FIG. 22 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Mobile communication devices, including cellular telephones, may be equipped with multiple radios that enable the devices to maintain multiple network connections simultaneously. The operation of one radio can interfere with operation of another radio through electromagnetic, conductive and/or capacitive interference, or through conflicting demands on system resources such as processor, power, antenna and or radio transceiver resources. Mobile communication devices may include coexistence management functions and/or circuits to mitigate coexistence issues.

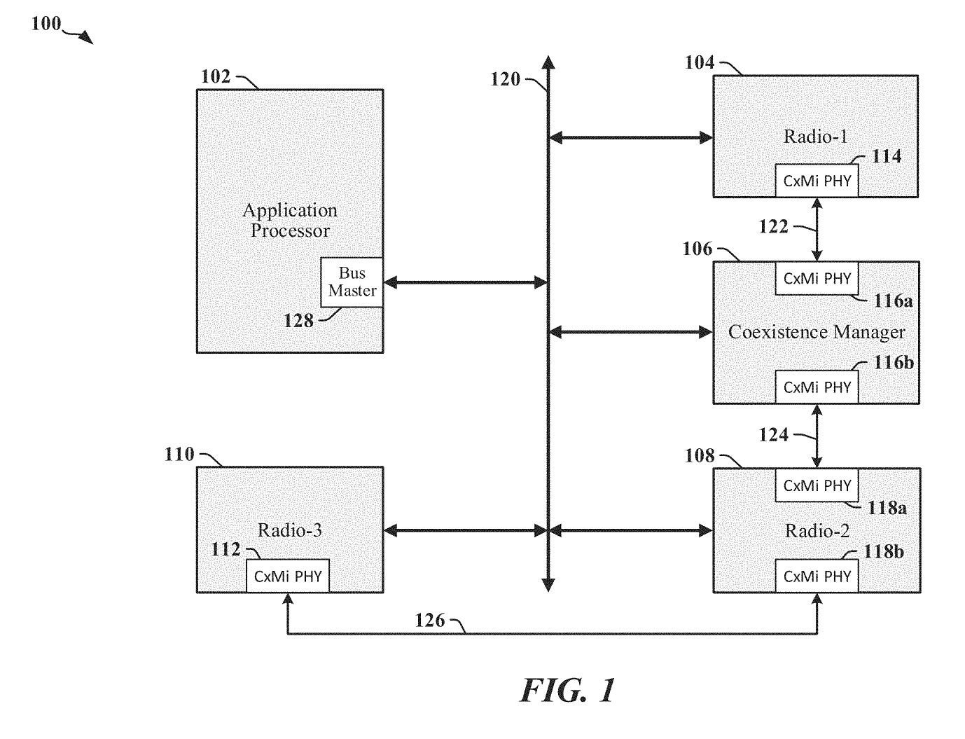

FIG. 1 illustrates certain aspects of a system 100 adapted to support coexistence management functions. The system may include an application processor 102 that is coupled to one or more peripheral devices 104, 106, 108, 110 through a serial bus 120. An interface circuit 128 of the application processor 102 may operate as a bus master, controlling communication over the serial bus 120. The application processor 102 may manage or control multiple radios 104, 108, 110, each of which may include one or more modems, transceivers, antennas, etc. In some instances, the multiple radios 104, 108, 110 may share certain circuits, antennas and other resources. The system 100 may include a coexistence manager 106 that may be a standalone device and/or may employ coexistence management functions and circuits 112, 114, 116a, 116b, 118a, 118b provided in one or more devices 102, 104, 106, 108, 110. In one example, the coexistence manager 106 may communicate with radios 104, 108 through point-to-point CxMi links 122, 124, respectively. In another example, coexistence management functions in two radios 108, 110 may interact through a point-to-point CxMi link 126. CxMi physical interface circuits provided in the radios 104, 108, 110 and/or coexistence manager 106 may be based on a UART. Each CxMi link 122, 124, 126 consumes at least two pins on each device for full-duplex operation.

An example mobile device may include various radios to provide a variety of functions for the user. For purposes of this example, a cellular telephone may include third generation (3G), fourth generation (4G) and/or fifth generation (5G) radios for voice and data, an IEEE 802.11 (WiFi) radio, a Global Positioning System (GPS) radio, and/or a Bluetooth radio, where two or more radios may operate simultaneously.

The coexistence manager 106 and/or coexistence functions and circuits 112, 114, 116a, 116b, 118a, 118b can be configured to manage operation of respective radios 104, 108, 110 in order to avoid interference and/or other performance degradation associated with collisions between respective radios 104, 108, 110. Coexistence management functions typically require deterministic communication of commands, configuration and other information. A point-to-point UART based link can provide sufficiently low latency to support coexistence management functions. Conventional shared communication links and communication protocols may be unable to meet the latency requirements needed to support coexistence management functions.

Certain aspects disclosed herein provide systems, apparatus and techniques by which CxMi communication links can be virtualized such that CxMi information can be timely transported as virtual general-purpose input/output (VGPIO or VGI) over a serial bus configured to operate as a multi-point VGI (MP-VGI) bus.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

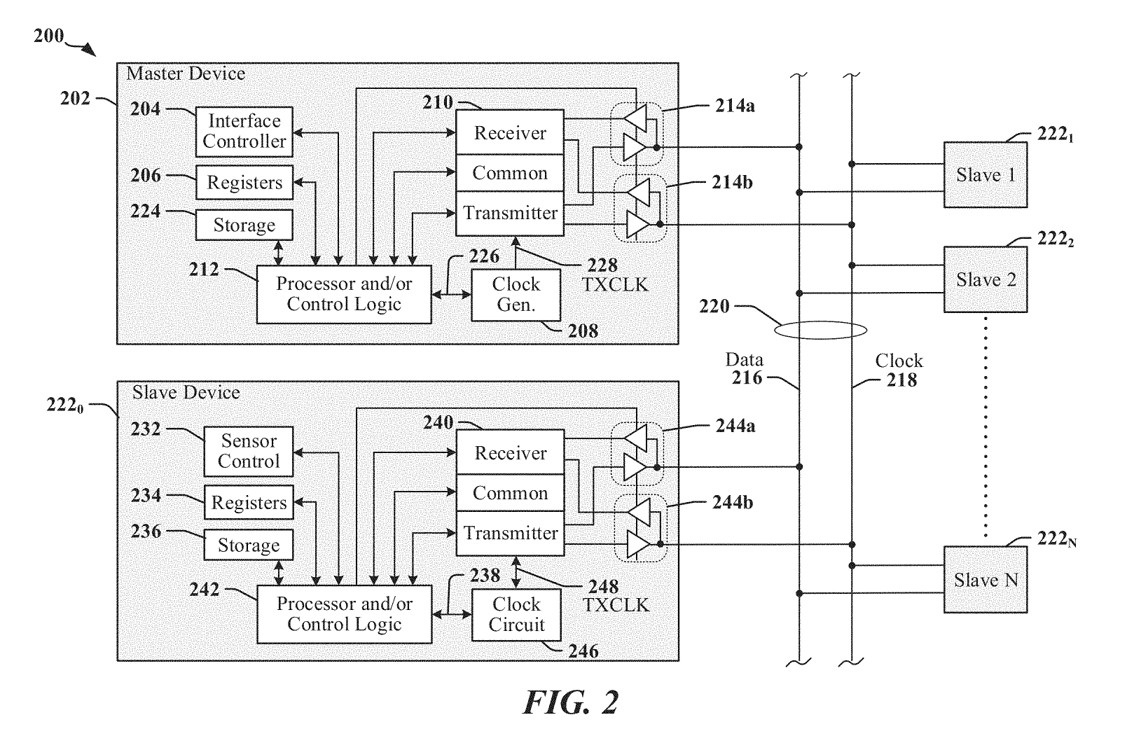

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an applications processor, SoC or ASIC. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master 202. Certain types of bus can support multiple bus masters 202.

In one example, a master device 202 may include an interface controller 204 that may manage access to the serial bus, configure dynamic addresses for slave devices 222₀-222_{N} and/or generate a clock signal 228 to be transmitted on a clock line 218 of the serial bus 220. The master device 202 may include configuration registers 206 or other storage 224, and other control logic 212 configured to handle protocols and/or higher level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with RFFE, I2C, I3C, SPMI, or other protocols. At least one device 202, 222₀-222_{N} may be configured to operate as a master device and a slave device on the serial bus 220. Two or more devices 202, 222₀-222_{N} may be configured to operate as a master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

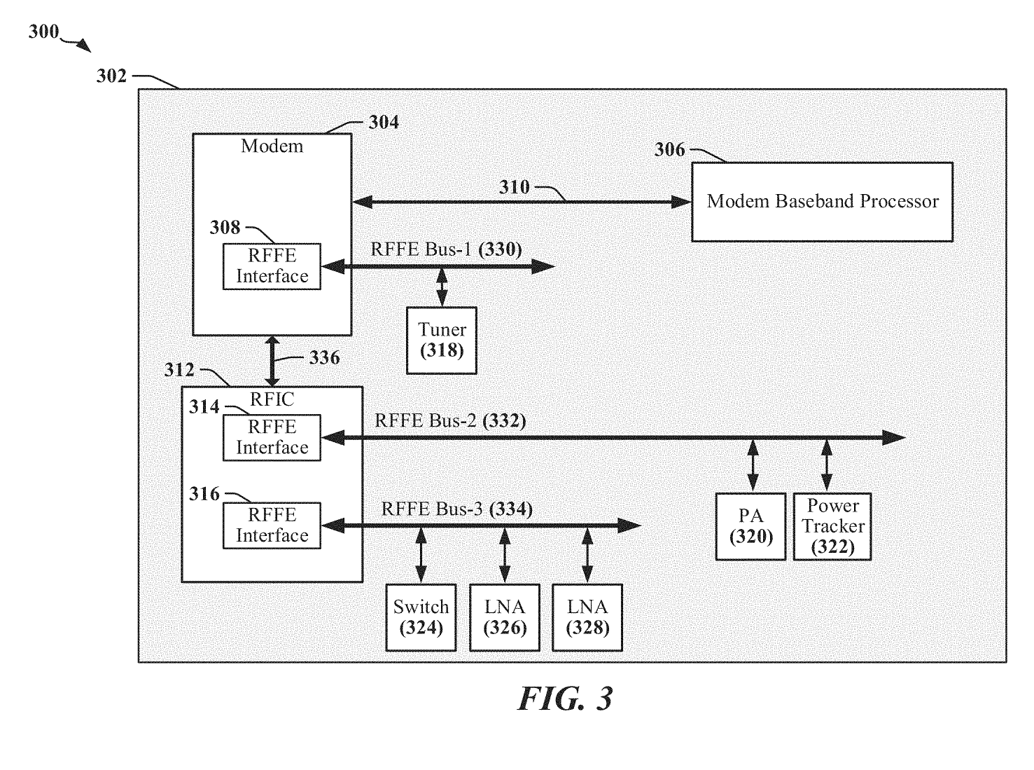

FIG. 3 is a block diagram 300 illustrating a second example of a configuration of communication links in a chipset or device 302 that employs multiple RFFE buses 330, 332, 334 to couple various RF front-end devices 318, 320, 322, 324, 326 328. In this example, a modem 304 includes an RFFE interface 308 that couples the modem 304 to a first RFFE bus 330. The modem 304 may communicate with a baseband processor 306 and a Radio-Frequency IC (RFIC 312) through one or more communication links 310, 336. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the device 302 may be implemented with one or more baseband processors 306, modems 304, RFICs 312, multiple communications links 310, 336, multiple RFFE buses 330, 332, 334 and/or other types of buses. The device 302 may include other processors, circuits, modules and may be configured for various operations and/or different functionalities. In the example illustrated in FIG. 3, the Modem is coupled to an RF tuner 318 through its RFFE interface 308 and the first RFFE bus 330. The RFIC 312 may include one or more RFFE interfaces 314, 316, controllers, state machines and/or processors that configure and control certain aspects of the RF front-end. The RFIC 312 may communicate with a PA 320 and a power tracking module 322 through a first of its RFFE interfaces 314 and the second RFFE bus 332. The RFIC 312 may communicate with a switch 324 and one or more LNAs 326, 328.

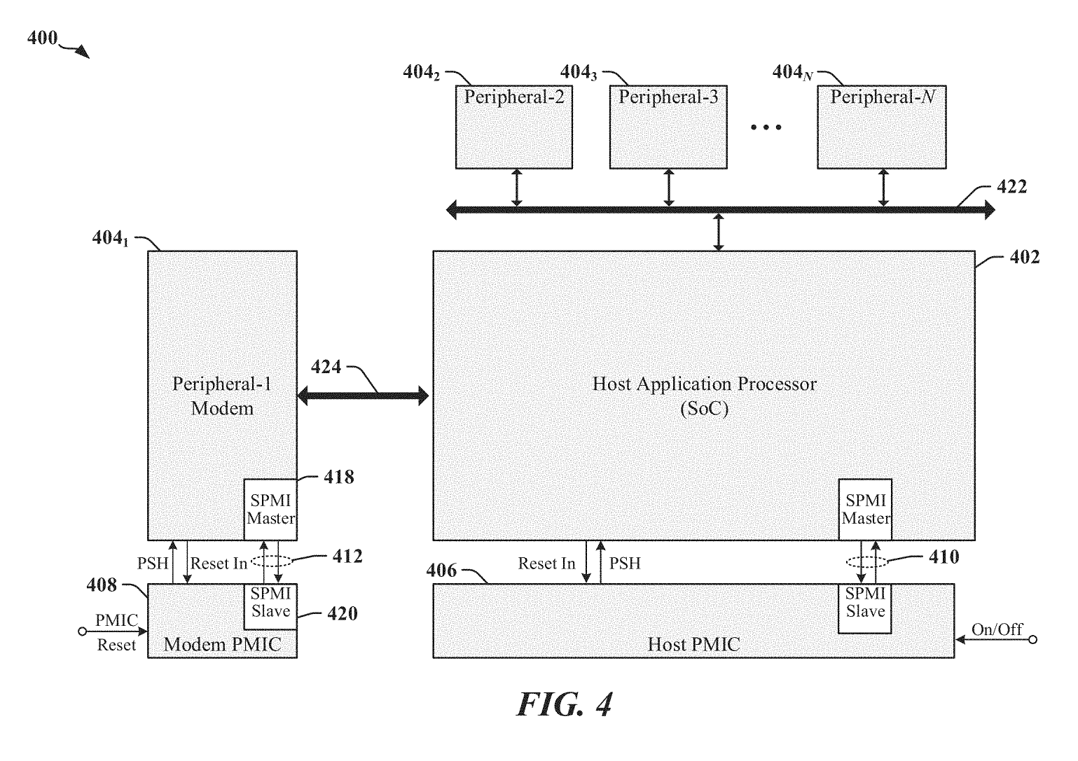

The MIPI Alliance SPMI standards and protocols specify a hardware interface that may be implemented between baseband or application processors and peripheral components to support a variety of data communication functions including data communication related to power management operations. FIG. 4 illustrates an example of a system 400 which includes data communication links 410, 412, where each of the data communication links 410, 412 is configured as a two-wire serial bus operated in accordance with SPMI protocols. In one example, a first data communication link 410 may be used to connect an integrated power controller of an application processor 402 with a voltage regulation system in a first power management integrated circuit (PMIC 406), and a second data communication link 412 may be used to connect an integrated power controller of a modem 404₁ with a voltage regulation system in a second PMIC 408. The data communication links 410, 412 can be used to accurately monitor and control processor performance levels required for a given workload or application and dynamically control the various supply voltages in real time based on the performance levels. The data communication links 410, 412 can be used to carry other types of data between the application processor 402 and the first PMIC 406 and/or between the modem 404₁ and the second PMIC 408. SPMI data communication links may be implemented as multi-drop serial links to connect a variety of different devices and to carry other types of data. Some SPMI data communication links may be optimized for real-time power management functions. Some SPMI data communication links may be used as a shared bus that provides high-speed, low-latency connection for devices, where data transmissions may be managed according to priorities assigned to different traffic classes.

The system 400 illustrated in FIG. 4 includes an application processor 402 that may serve as a host device on various data communication links 422, 424, multiple peripherals 404₁-404_{N}, and one or more PMICs 406. The application processor 402 and the modem 404₁ may be coupled to respective PMICs 406, 408 using power management interfaces implemented using SPMI masters 414, 418. The SPMI masters 414, 418 communicate with corresponding SPMI slaves 416, 420 provided in the PMICs 406, 408 to facilitate real-time control of the PMICs 406, 408. The application processor 402 may be coupled to each of the peripherals 404₁-404_{N} using different types of data communication links 410, 412. For example, the data communication links 410, 412 may be operated in accordance with one or more protocols such as the RFFE, SPMI, I3C protocols.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message. In another example, bus latency may be measured as the time elapsed between a message becoming available for transmission and the commencement of transmission of the message. Other measures of bus latency may be employed. Bus latency typically includes delays incurred while higher priority messages are transmitted, interrupt processing, the time required to terminate a transaction in process on the serial bus, the time to transmit commands causing bus turnaround between transmit mode and receive mode, bus arbitration and/or command transmissions specified by protocol.

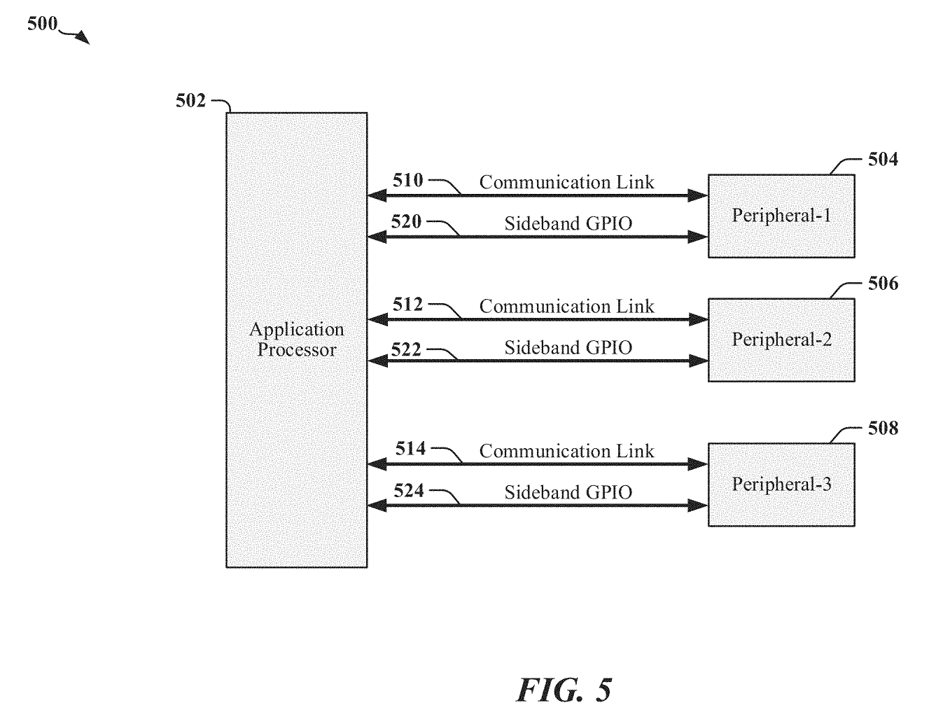

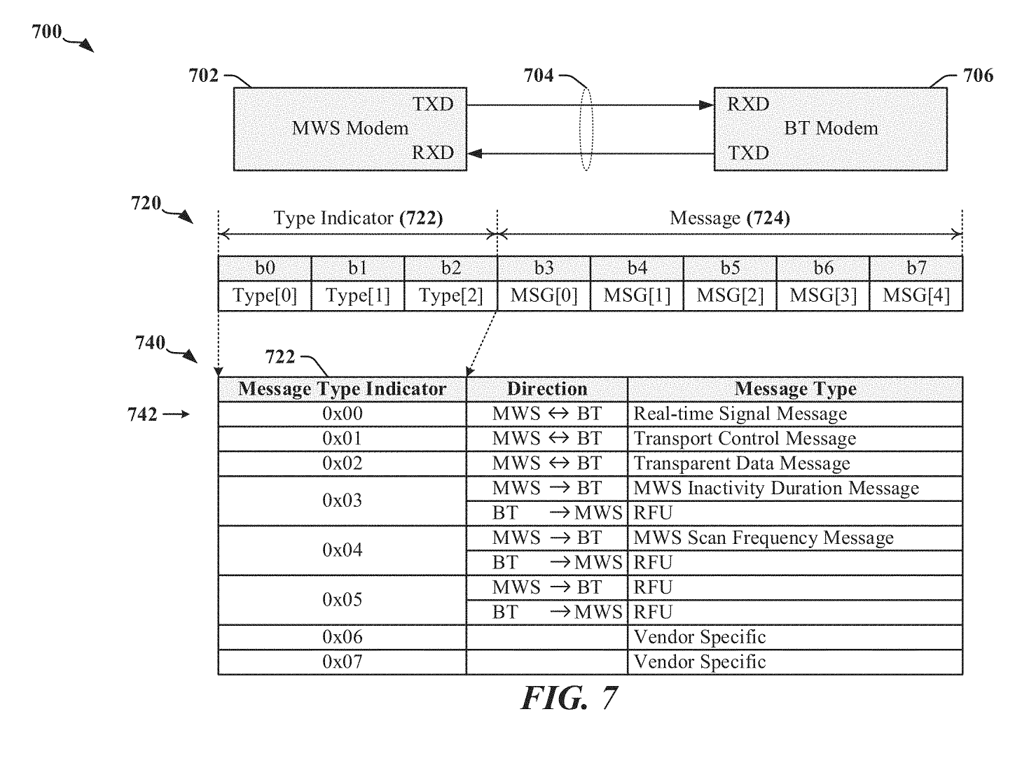

A virtual GPIO message is one example of a low-latency message. Other low-latency messages include WCI-2 message types such as Type-0 and Type-2 (see Message Type Indicator 0x00, 0x02 in FIG. 7), and messages that carry regular or non-event messages. Mobile communication devices, and other devices that are related or connected to mobile communication devices, increasingly provide greater capabilities, performance and functionalities. In many instances, a mobile communication device incorporates multiple IC devices that are connected using a variety of communication links. For example, FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514, which may be operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband GPIO 520, 522, 524, and in some instances the number of connections needed for sideband GPIO 520, 522, 524 can exceed the number of connections used for a communication link 510, 512, 514.

GPIO provides generic pins/connection points that may be customized for particular applications. For example, a GPIO pin may be programmable to function as an output pin, an input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by both the Application Processor 502 and a peripheral device 504, 506, 508. With increased device complexity, the increased number of GPIO pins used for IPC communication may significantly increase manufacturing cost and limit GPIO availability for other system-level peripheral interfaces. In some devices, the state of GPIO associated with a communication link, may be captured, serialized and transmitted over a data communication link. In one example, captured GPIO state may be transmitted in virtual GPIO (VGI) message in packets over a multi-drop, serial bus operated in accordance with an RFFE, I2C, I3C, SPMI, or other protocol.

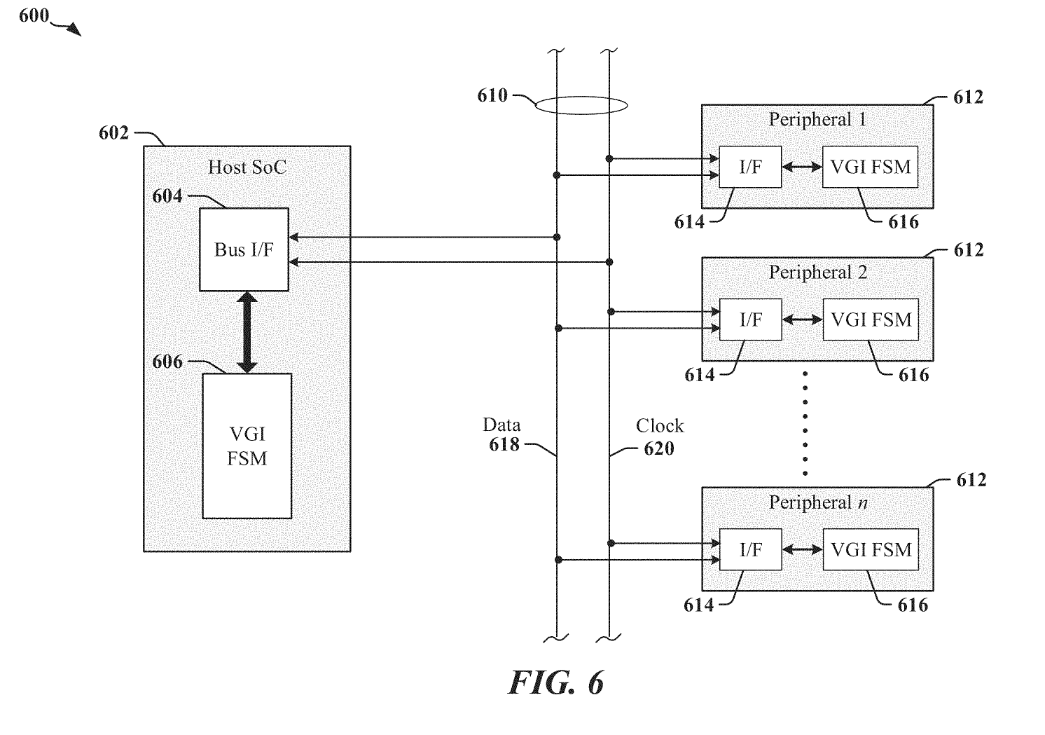

FIG. 6 illustrates an example of an apparatus 600 that uses a multi-drop, serial bus 610 to couple various devices including a host SoC 602 and a number of peripheral devices 612. The host SoC 602 may include a virtual GPIO finite state machine (VGI FSM 606) and a bus interface 604, where the bus interface 604 cooperates with corresponding I3C bus interfaces 614 in one or more peripheral devices 612 to provide a communication link between the host SoC 602 and the peripheral devices 612. Each peripheral device 612 includes a VGI FSM 616. In the illustrated example, messages exchanged between the SoC 602 and a peripheral device 612 may be serialized and transmitted over a multi-drop serial bus 610 in accordance with an RFFE, I2C, I3C, SPMI, or other protocol. In some examples, the host SoC 602 may include or support multiple types of interface, including I2C and/or RFFE interfaces. In other examples, the host SoC 602 may include a configurable interface that may be employed to communicate using I2C, I3C, RFFE and/or another suitable protocol. In various examples, a multi-drop serial bus 610, may transmit a data signal over a data wire 618 and a clock signal over a clock wire 620.

### Examples of CxMi Communication

FIG. 7 illustrates an example of a conventional CxMi implementation 700 that may include a point-to-point UART-based link that may be operated at 4 Mbps. In the example, a first modem 702 is configured for operation using a mobile wireless service (MWS) radio access technology and a second modem 706 is configured for Bluetooth (BT) communications. The modems 702, 706 exchange CxMi messages, commands and/or control information over a two-wire UART-based point-to-point CxMi link 704. In one example, data is clocked on the CxMi link 704 at 4 megabits per second (Mbps). Each 8-bit byte of data transferred through the CxMi link 704 is preceded by a start bit and followed by a stop bit, and transmission is accomplished in 10 clock cycles, or 2.5 μs.

FIG. 7 includes an example of a datagram 720 for a wireless coexistence interface (WCI). In some implementations, the datagram 720 may comply or be compatible with a WCI-2 datagram that is defined for communication using a UART-based interface. The datagram includes a type indicator field 722 and a message field 724. The type indicator field 722 has a length of 3 bits that identify the content of the message field 724. The 8 message types are defined in the table 740 in FIG. 7. The Type-0 message 742 has a value of 0x00 and can carry VGI-like event messages with strict latency targets. When the CxMi link 704 is operated at 4-Mbps, transmissions including a Type-0 message 742 include 1 Start bit, 8 data-bits and one Stop-bit for a total of 10 bits. Transmission time is 2.5 μs and Type-0 messages 742 are subjected to hard real-time, deterministic constraints, where transmissions are expected to be completed in less than 3 μs, for example.

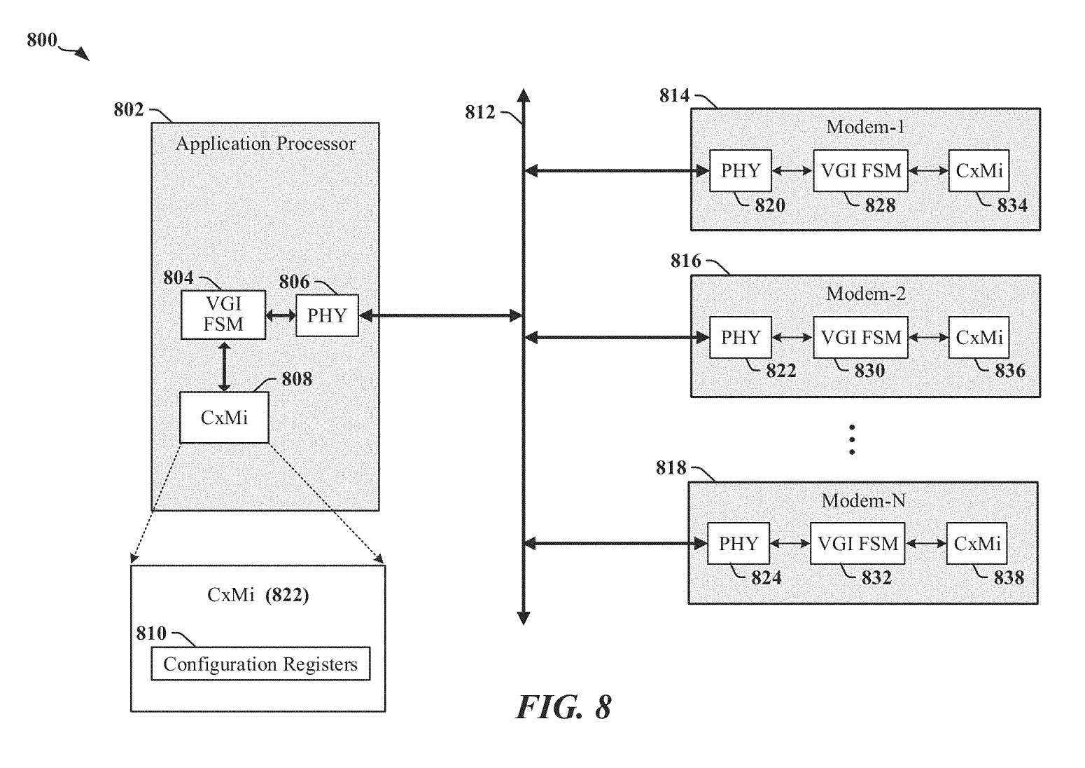

Certain aspects disclosed herein enable CxMi messages to be transmitted as VGI over a MP-VGI bus. FIG. 8 illustrates an example of a system 800 adapted to transport CxMi messages within specified and/or application-defined time constraints. The messages may include one or more Type-0 messages 742. A multi-drop, serial bus 812 couples an Application Processor 802 to one or more modems 814, 816, 818. The Application Processor 802 may include a virtual GPIO finite state machine (VGI FSM 804) and a physical bus interface (PHY 806), where the PHY 806 cooperates with corresponding PHYs 820, 822, 824 in the modems 814, 816, 818 to provide a communication link between the Application Processor 802 and the modems 814, 816, 818. Each modem 814, 816, 818 includes a VGI FSM 828, 830, 832. In the illustrated example, communications between the Application Processor 802 and a modem 814, 816, 818 may be serialized and transmitted over the multi-drop serial bus 812 in accordance with an RFFE, SPMI, or other protocol.

The VGI FSMs 804, 828, 830, 832 may be configured to recognize datagrams that carry CxMi messages, and these messages may be directed to a corresponding CxMi encoder/decoder 808, 834, 836, 838 that converts state of physical CxMi GPIO pins to VGI for transmitting and received VGI to state of physical CxMi GPIO pins. Each CxMi encoder/decoder 808, 834, 836, 838 may include configuration registers that determine a mode of CxMi to VGI conversion. In some implementations, CxMi to VGI conversion includes feeding non-Type-0 messages to an appropriate message sink in a receiving control CPU.

### SPMI/RFFE Datagrams for CxMi VGI

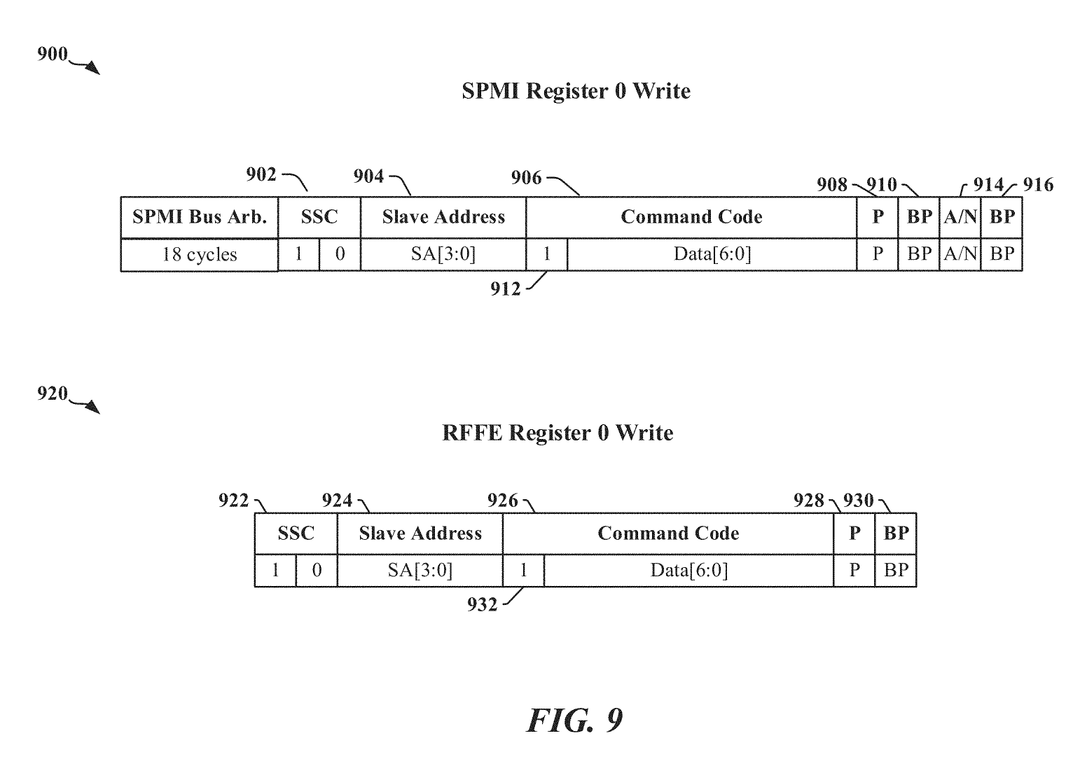

FIG. 9 illustrates datagram structures 900, 920 for Register-0 Write command in accordance with SPMI and RFFE protocols, respectively. Register-0 Write commands are transmitted in the shortest datagrams defined by both SPMI and RFFE protocols. In both protocols, the datagram structures 900, 920 commence with transmission of a two-bit sequence start condition (SSC 902, 922) followed by a four-bit slave address 904, 924 or other device identifier. The 8-bit command code 906, 926 is transmitted next. The 8-bit command code 906, 926 is the only currently-defined command code that has a most significant bit (MSB 912, 932) set to 1. The command code 906, 926 is followed by a parity bit 908, 928 and bus park signaling 910, 930. In SPMI protocols, an acknowledge/not acknowledge bit 914 is transmitted followed by second bus park signaling 916. Other SPMI and RFFE include additional fields including, for example, register address fields and one or more data bytes.

According to certain aspects disclosed herein, the Register-0 Write command in SPMI and RFFE protocols may be adapted to carry CxMi information within the timing constraints defined by CxMi protocols. The Register-0 Write commands may be configured according to one of two modes. A configuration register 810 in both master and slave devices can be used to select between modes. First mode (MP-VGI Mode A) datagrams and second mode (MP-VGI Mode B) datagrams may be transmitted on the serial bus in place of conventional Register-0 Write commands.

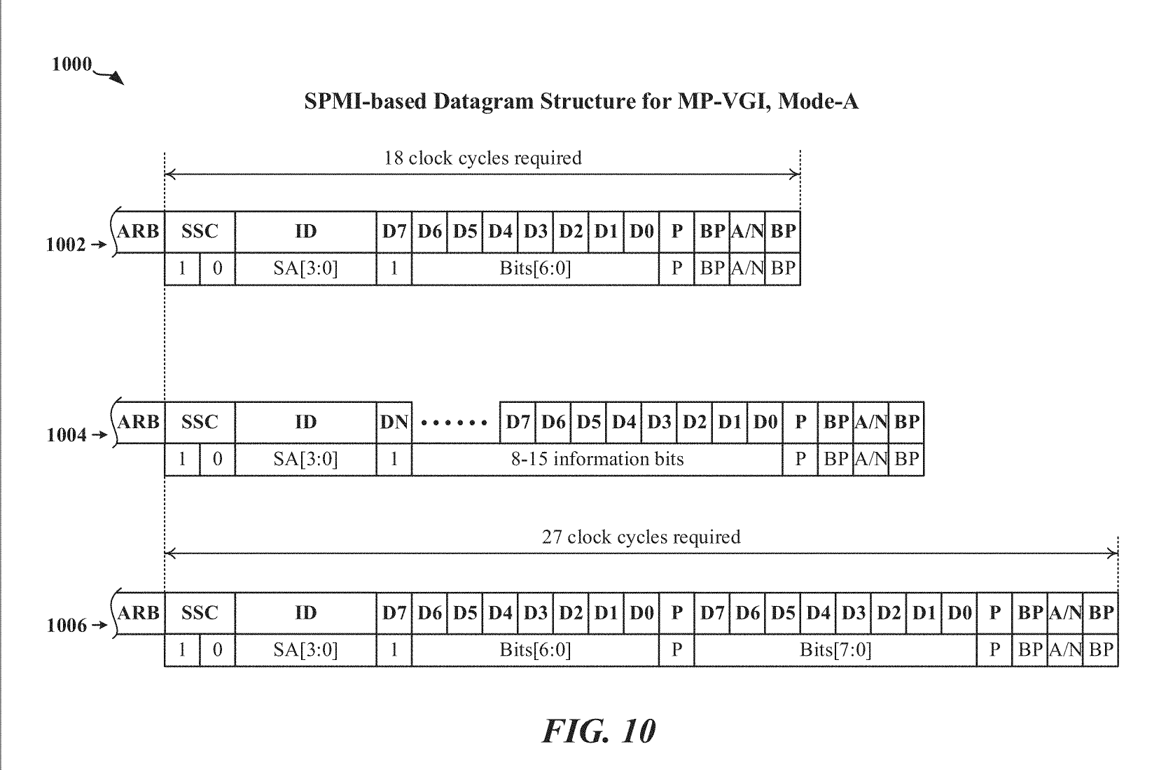

FIG. 10 illustrates examples of Mode-A datagrams 1000 for SPMI-based MP-VGI. In Mode A, the previously fixed 8-bit length Write Register-0 datagram can be redefined as a variable length field. In one example, the extended payload can accommodate datagram sizes of between 7 and 15 bits. In another example, the payload includes up to two bytes, that can provide a transmitting device address, and/or VGI low-latency parameter data.

In FIG. 10, a first, minimum-length datagram 1002 may be transmitted with a one-byte payload containing 7 usable information bits. A second, variable-length datagram 1004 may be transmitted with an additional 1 to 8 bits of payload to achieve between 8 bits and 15 bits of payload data, while a third, maximum-length datagram 1006 may be transmitted with 15 bits of payload data. When transmitted in accordance with SPMI protocols, 18 bus clock cycles are used to transmit the minimum-length datagram 1002, and 27 bus clock cycles are used to transmit the maximum-length datagram 1006.

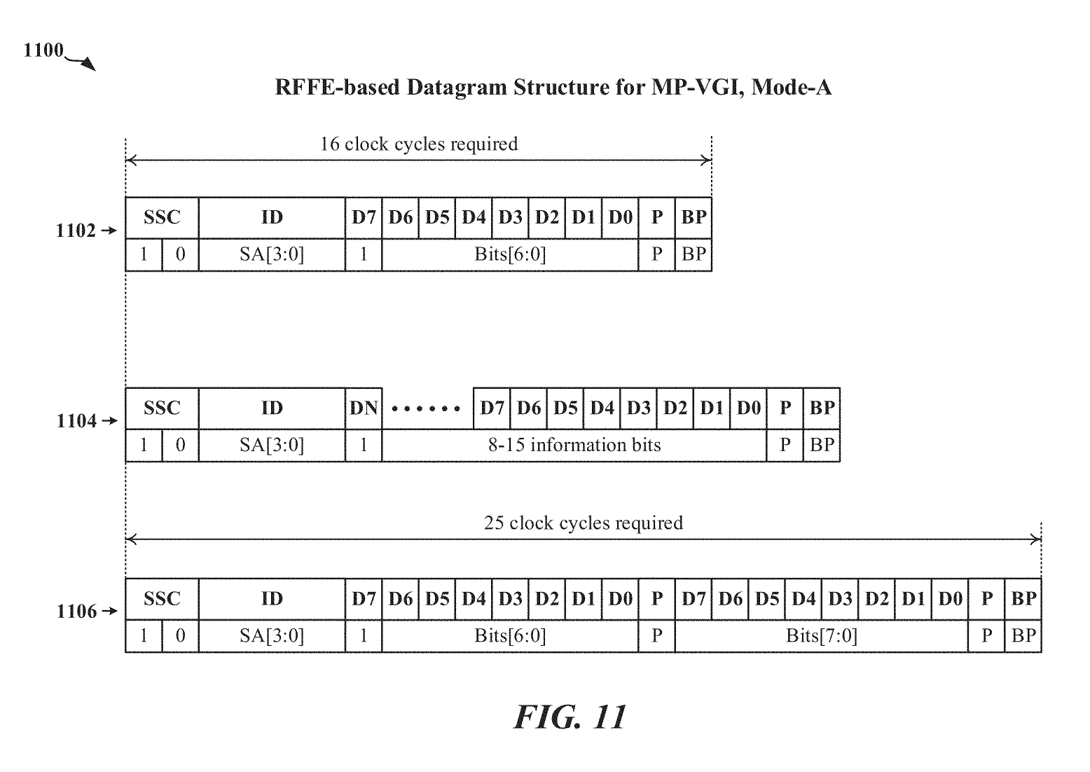

FIG. 11 illustrates examples of Mode-A datagrams 1100 for RFFE-based MP-VGI. In Mode A, the previously fixed 8-bit length Write Register-0 datagram can be redefined as a variable length field. In one example, the extended payload can accommodate datagram sizes of between 7 and 15 bits. In another example, the payload includes up to two bytes, that can provide a transmitting device address, and/or VGI low-latency parameter data.

A first, minimum-length datagram 1102 may be transmitted with a one-byte payload containing 7 usable information bits. A second, variable-length datagram 1104 may be transmitted with an additional 1 to 8 bits of payload, to achieve between 8 bits and 15 bits of payload data, while a third, maximum-length datagram 1106 may be transmitted with 15 bits of payload data. When transmitted in accordance with RFFE protocols, 16 bus clock cycles are used to transmit the minimum-length datagram 1102, and 25 bus clock cycles are used to transmit the maximum-length datagram 1106.

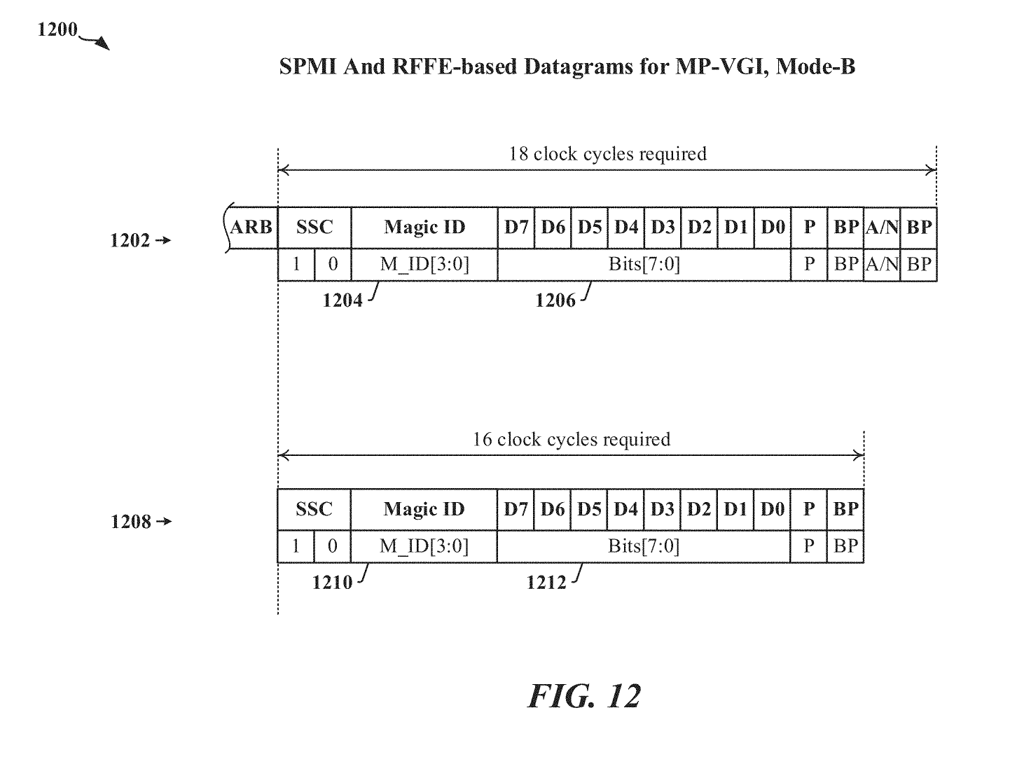

FIG. 12 illustrates examples of Mode B Write Register-0 datagrams 1200 for SPMI-based MP-VGI and RFFE-based MP-VGI, respectively. A Mode B Write Register-0 datagram 1202, 1208 is identified by a magic address 1204, 1210 that replaces the slave address field in a conventional SPMI or RFFE datagram. The magic address 1204, 1210 selects one or more devices to receive the Mode B datagram 1202, 1208, and explicitly identifies the content of the command code field 1206, 1212 of the Mode B Write Register-0 datagram 1202, 1208 as including CxMi VGI. For example, the 8-bit byte in the datagram 720 (see FIG. 7) transmitted over a conventional UART interface may be carried in the command code field 1206, 1212 of the Mode B datagram 1202, 1208. 18 bus clock cycles are used to transmit the Mode B Write Register-0 datagram 1002 in accordance with SPMI protocols, and 16 bus clock cycles are used to transmit the Mode B Write Register-0 datagram 1208 in accordance with RFFE protocols. The magic address 1204, 1210 may identify the recipient device and/or a destination address. In some implementations, the recipient device can identify the unique address (e.g., slave address) of the sending device by capturing the slave address that wins arbitration.

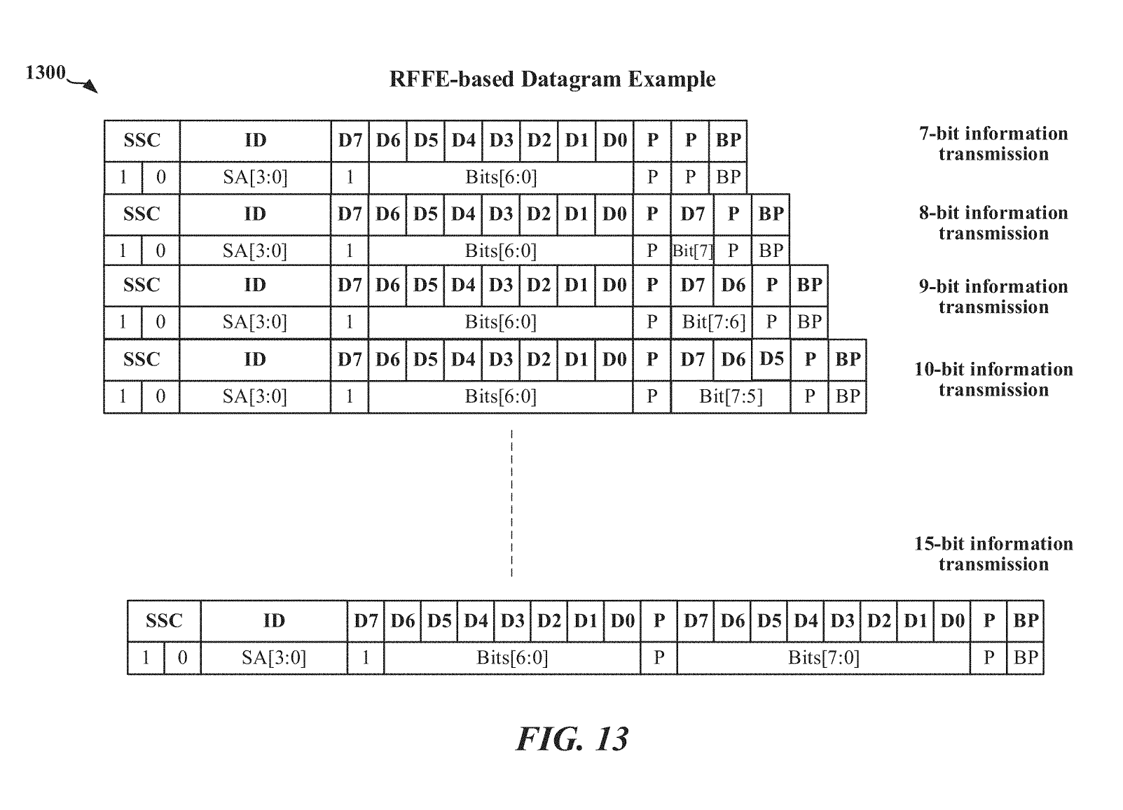

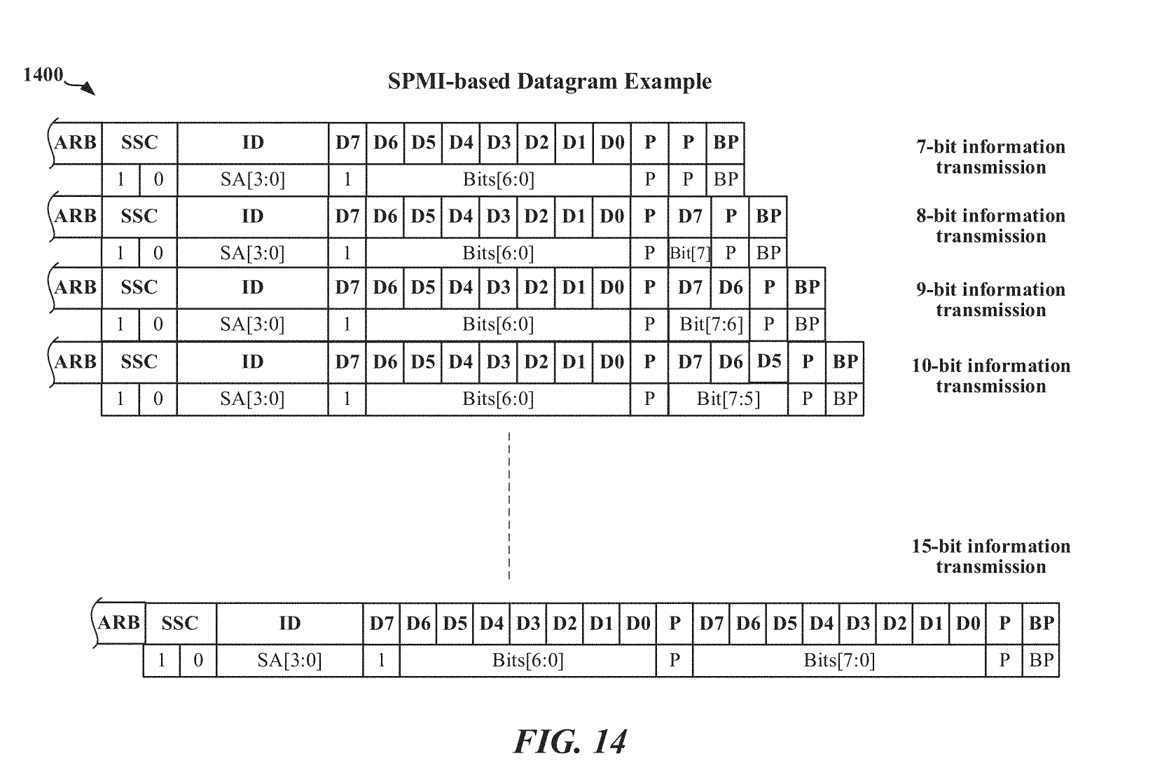

Referring also to FIGS. 10 and 11, which relate to a Mode-A (Appended byte) operation that enables a datagram payload of between 7 and 15 bits to be transmitted in the modified command frame, FIGS. 13 and 14 illustrate datagrams 1300, 1400 that may be provided in an implementation that involves multi-radio coexistence management. The datagrams 1300, 1400 may carry payloads that include identification and/or parameters related to the current or upcoming state of radios present in the transmitting device, enabling receiving devices with embedded radios to take action on these parameters to mitigate interference. In some examples, the parameters may include a Radio Identifier or Radio-ID, and may provide the following information:
Radio type, e.g. the transmitting radio carrier is one or more of: cellular (3G/LTE/5G), WIFI, Bluetooth, etc., where by carrier is meant a discrete segment of radio frequency spectrum.
Number of carriers: the number of discrete active transmitting carriers.
Radio band (frequency), the frequency of the radio carrier, e.g. 800 MHz, 900 MHz, 1800 MHz, 1900 MHz, 2400 MHz, 5800 MHz, 28000 MHz, 38000 MHz
Radio operating mode, e.g. FDD (frequency division duplex) or TDD (time division duplex), noting that each carrier within a set of active carriers may operate in a different mode.
Radio concurrency, e.g. the transmitting radio consist of two independent phones/transmitters on their own frequencies. In cellular often known as DSDA (Dual standby, Dual Access) and in WLAN often known as DBS (Dual band simultaneous). In cellular LTE, a form of radio concurrency is LTE Carrier Aggregation (CA), including Intra-band CA (e.g. two carriers in the same band, e.g. intra-band CA for Band 40) and inter-band CA (e.g. B7+B3), and where each carrier can individually/jointly have coexistence issues with other radios.
Radio TX power, specifies the power level of each active transmitting carrier. It may also include instructions for limiting the power on the receiver's radio in its upcoming transmission.
Radio timing, specifies the timing or timing offset of an active TDD carrier.
Radio subframe, specifies the active subframe marker of an active FDD carrier.

The Radio-ID set of parameters may be encoded into “codes” within a “code space” such as for inclusion in MP-VGI Mode A. In one implementation for example, 2¹⁵ or 32,768 possible codes are available when 15 bits are identified for transmission in MP-VGI Mode A. In another implementation, some portion of the 15 bits may be used to identify the destination radio to which the broadcast message is sent or for some other function, reducing the number of available codes. For example, 12 of the 15 bits provide for 2¹² or 4096 possible codes when 3 of the 15 bits are used to identify the destination radio.

In some implementations, a Radio-ID packing function is employed or configured to package or encode the Radio-ID information into the 15-bit code. As an example, the Radio type may identify a radio access technology (RAT) such as 3G, 4G LTE, and/or 5G, or a RAT such as Wi-Fi, Bluetooth (BT). The number of carriers may be defined, where a carrier includes a discrete segment of radio frequency spectrum.

In one example, the following parameters apply to three defined carriers respectively:
The Radio band may be: 800 MHz, 900 MHz, 2400 MHz.
The Radio operating mode may (TDD or FDD) may be: FDD, FDD, TDD, where TDD refers to time-division duplex mode and FDD refers to frequency-division duplex mode.
The Radio concurrency may be: WWAN, WWAN, WLAN.
The Radio TX power may be: 30 dBm, 20 dBm, 13 dBm.
The Radio timing may be: 0 ms, 0 ms, 10 ms.
The Radio subframe may be: 10, 0, 0.
   In this example, the identified parameters may be grouped as “(3, 800, 900, 2400, FDD, FDD, TDD, WWAN, WWAN, WLAN, 30, 20, 13, 0, 0, 10, 10, 0, 0)” may be encoded into one 15-bit code within the available 32,768 code spaces. For example, the identified parameters may be identified as code “32000” from the available 32,768 codes, and all receiving devices would decode code “32000” to identify the radio parameters. While this represents one coding and decoding scheme any other scheme is applicable to represent the radio parameters in a 7-15 bit payload.

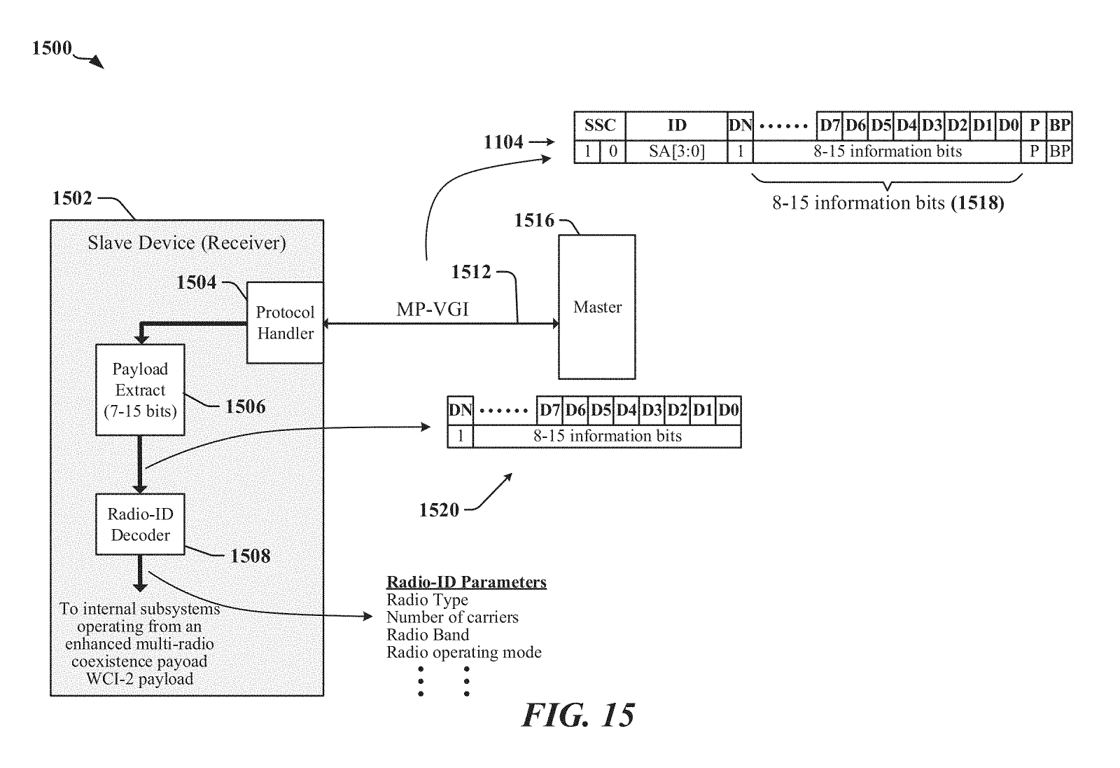

FIG. 15 illustrates the use of MP-VGI Mode-B in a system 1500 to support transportation of Radio-ID parameters that may be conventionally transported through a WCI-2 UART link. A master device 1516 and a slave device 1502 may be configured to exchange Radio-ID parameters 1520 over an MP-VGI link 1512. The MP-VGI link 1512 may be implemented using a serial bus operated in accordance with certain of the SPMI Mode-A protocols disclosed herein. A datagram 1104 received at the slave device 1502 may be provided to a protocol handler 1504 that extracts the information bits 1518 in the payload of the datagram 1104. The information bits 1518 may be forwarded to a module or circuit 1506 configured to extract the Radio-ID parameters 1520 from the payload. The Radio-ID parameters 1520 may be provided to a Radio-ID decoder 1508.

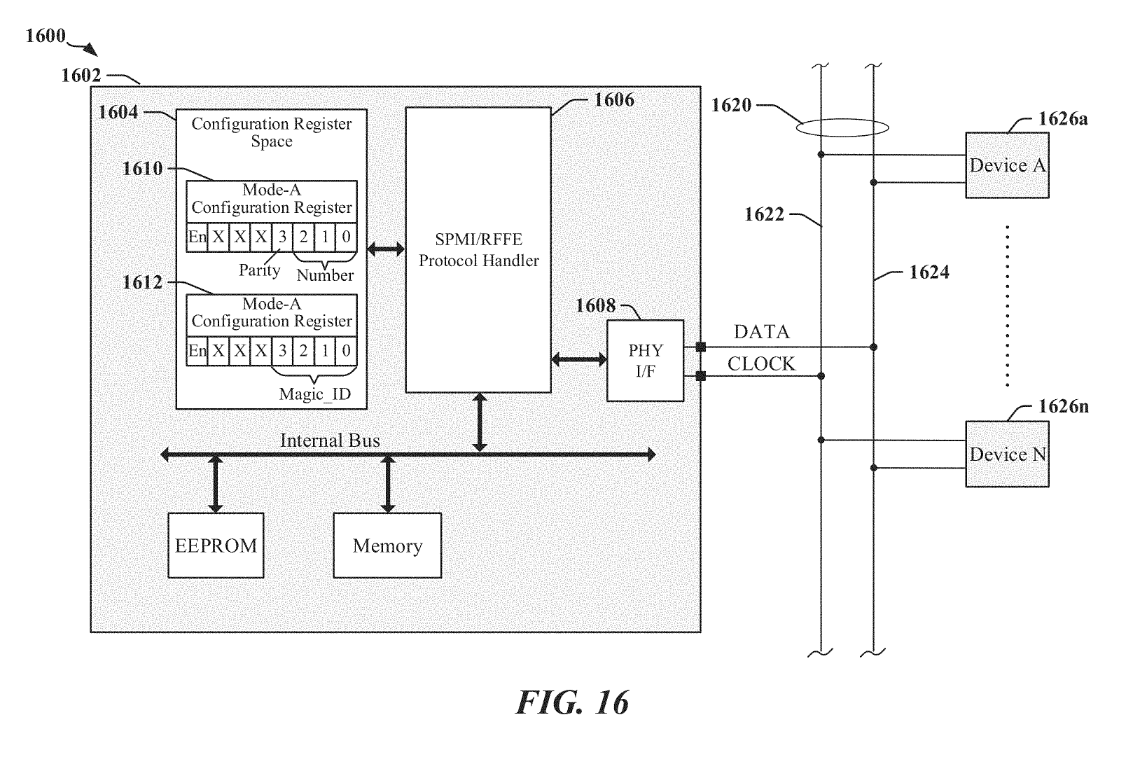

FIG. 16 illustrates a system 1600 that includes one or more devices 1602, 1626a-1626n that may be adapted in accordance with certain aspects disclosed herein. One device 1602 includes an SPMI and/or RFFE protocol handler 1606 coupled through physical layer circuits 1608 to a multi-wire serial bus 1620 that has a clock line 1622 and a data line 1624. The SPMI and/or RFFE protocol handler 1606 may include, or be coupled to CxMi logic that handles CxMi VGI traffic. One or more CxMi functions may be configured by control registers 1604, including Mode A configuration register 1610 and a Mode B configuration register 1612.

In one example, the Mode A configuration register 1610 includes a first bit (Bit 7) that determines whether Mode A is enabled, a second bit (Bit 3) that determines whether parity is enabled, and a group of bits (Bits [2:0]) that indicates how many extension bits are included in the Write Register-0 datagram, indicating 1 to 8 extension bits. Other bits may be reserved for other purposes.

In another example, the Mode B configuration register 1612 includes a first bit (Bit 7) that determines whether Mode B is enabled, and a group of bits (Bits [3:0]) that defines the magic address 1204, 1210. Other bits may be used or reserved for other purposes. Multiple Mode B configuration registers 1612 may be provided, where each Mode B configuration register 1612 provides a value for the magic address 1204, 1210.

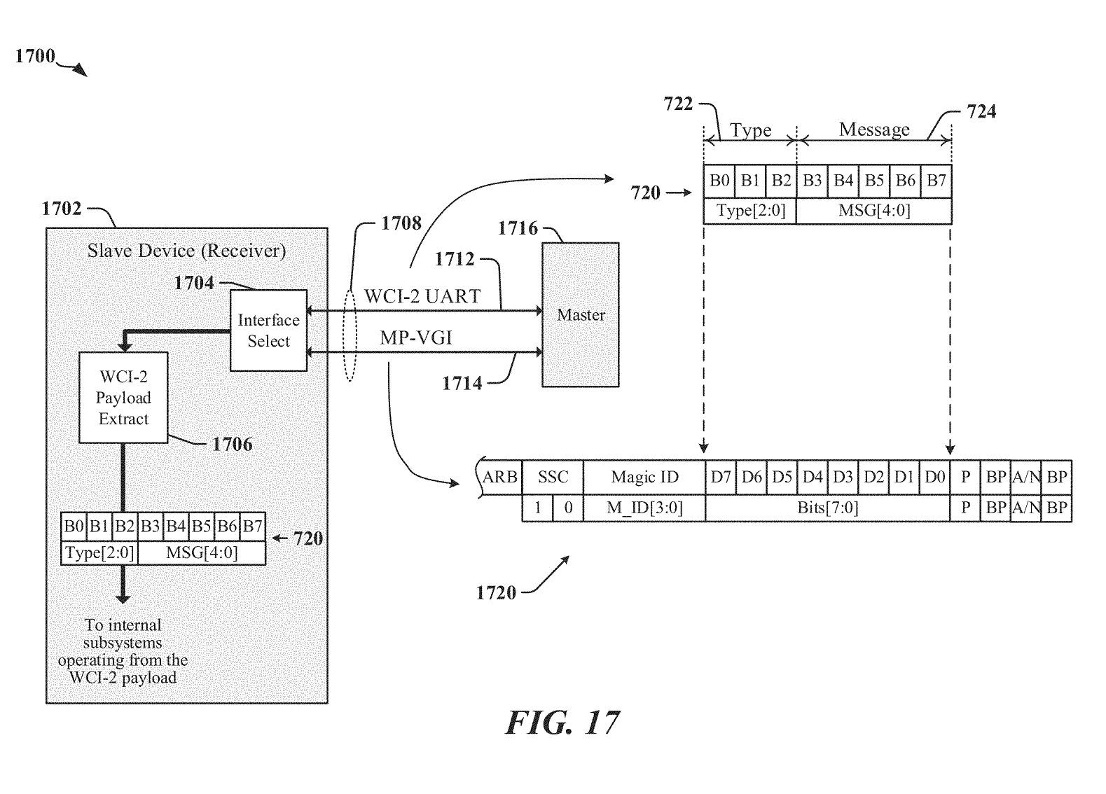

FIG. 17 illustrates a system 1700 that enables and/or supports selection between WCI-2 UART and MP-VGI interfaces for communication between a slave device 1702 and a master device 1716 in accordance with certain aspects disclosed herein. In one example, a serial datalink 1708 has a WCI-2 UART link 1712 (see FIG. 7) and a multi-point MP-VGI link 1714. In another example, the serial datalink 1708 may be configurable for operation as a point-to-point WCI-2 UART link for a first exchange of data, and as a multi-point MP-VGI interface for a second exchange of data. The MP-VGI interface may be operated in SPMI Mode-B (sees FIGS. 14 and 16) carrying the same WCI-2 protocol byte in the datagram 1720 (as illustrated in FIG. 7). The WCI-2 protocol byte includes the 3-bit Type field and 5-bit Data field. Because the same functional WCI-2 protocol 8-bit datagrams are carried across each interface, a device may select between the two interfaces using an Interface Selector 1704 and/or multiplexer. The WCI-2 protocol byte may be sent to internal subsystems, enabling a selection of the desired chip-to-chip interface UART or MP-VGI. In certain implementations, the WCI-2 payload may be extracted by an extractor circuit 1706 and provided to a legacy WCI-2 UART interface, enabling the legacy WCI-2 UART interface to be used with the MP-VGI interface without needing modifications to internal subsystems. In one example, VGI messages directed to the legacy WCI-2 UART interface may be decoded to control physical GPIO state at the legacy WCI-2 UART interface. In another example, physical GPIO state at the legacy WCI-2 UART interface may be encoded in VGI messages for transmission over the MP-VGI interface.

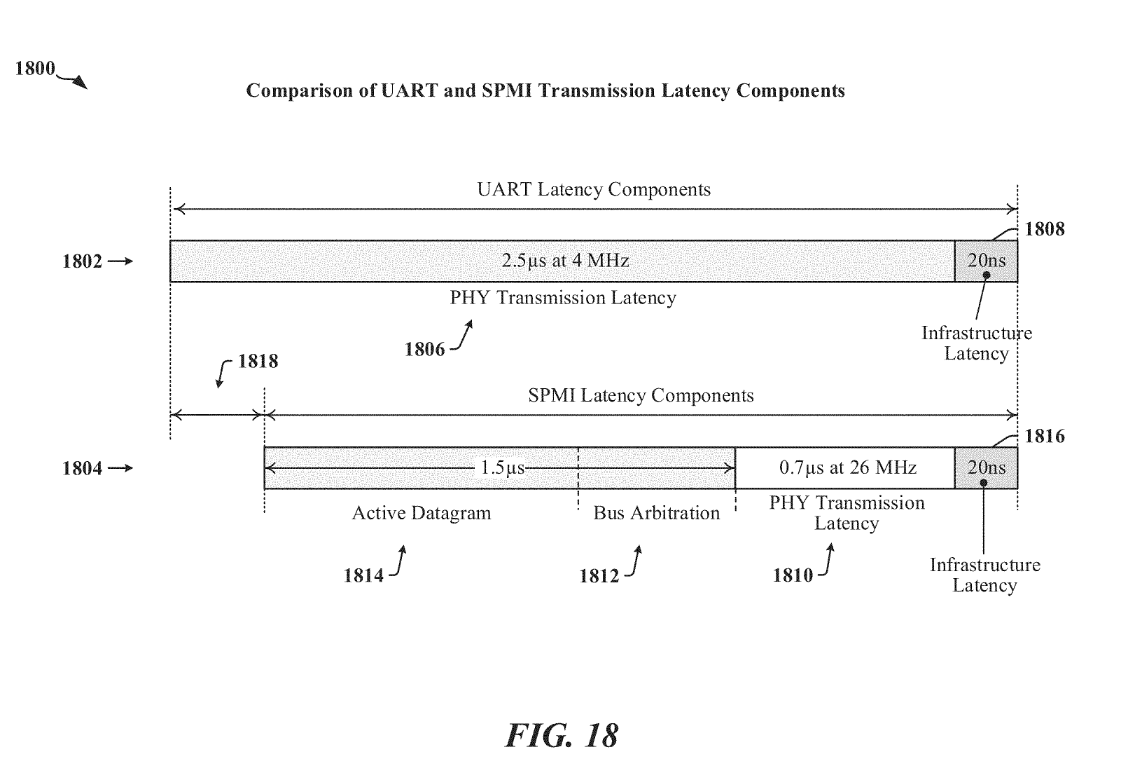

FIG. 18 provides a comparison 1800 of UART transmission latency components 1802 and SPMI transmission latency components 1804. The UART transmission latency components 1802 are primarily associated with physical layer transmission latency 1806, which corresponds to the transmission time of the 10 bits required by a UART to transmit an 8-bit byte. Infrastructure latency 1808 associated with on-chip logic propagation delays may be calculated as 20 ns. SPMI transmission latency components 1804 include physical layer transmission latency 1810, which corresponds to the transmission time of 18 bits transmitted over a serial bus clocked at 26 MHz, a latency time calculated as the combination of time 1814 for completion of an in-progress transmission and bus arbitration time 1812. Infrastructure latency 1816 associated with on-chip logic propagation delays may be calculated as 20 ns. The SPMI transmission can be accomplished with additional time 1818 to spare.

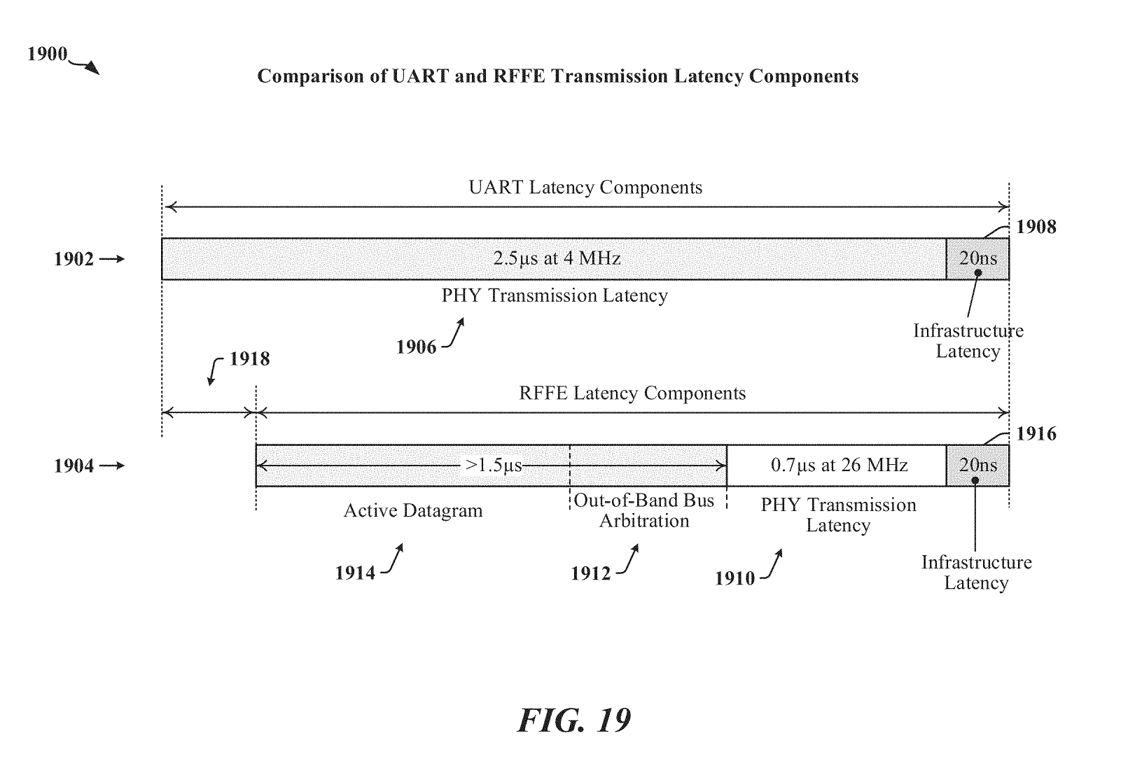

FIG. 19 provides a comparison 1900 of UART transmission latency components 1902 and RFFE transmission latency components 1904. The UART transmission latency components 1902 are primarily associated with physical layer transmission latency 1906, which corresponds to the transmission time of the 10 bits required by a UART to transmit an 8-bit byte. Infrastructure latency 1908 associated with on-chip logic propagation delays may be calculated as 20 ns. RFFE transmission latency components 1904 include physical layer transmission latency 1910, which corresponds to the transmission time of 18 bits transmitted over a serial bus clocked at 26 MHz, and a latency time calculated as the combined time 1914 for completion of an in-progress transmission and bus arbitration time 1912. Infrastructure latency 1916 associated with on-chip logic propagation delays may be calculated as 20 ns. The RFFE transmission can be accomplished with additional time 1918 to spare.

### Examples of Processing Circuits and Methods

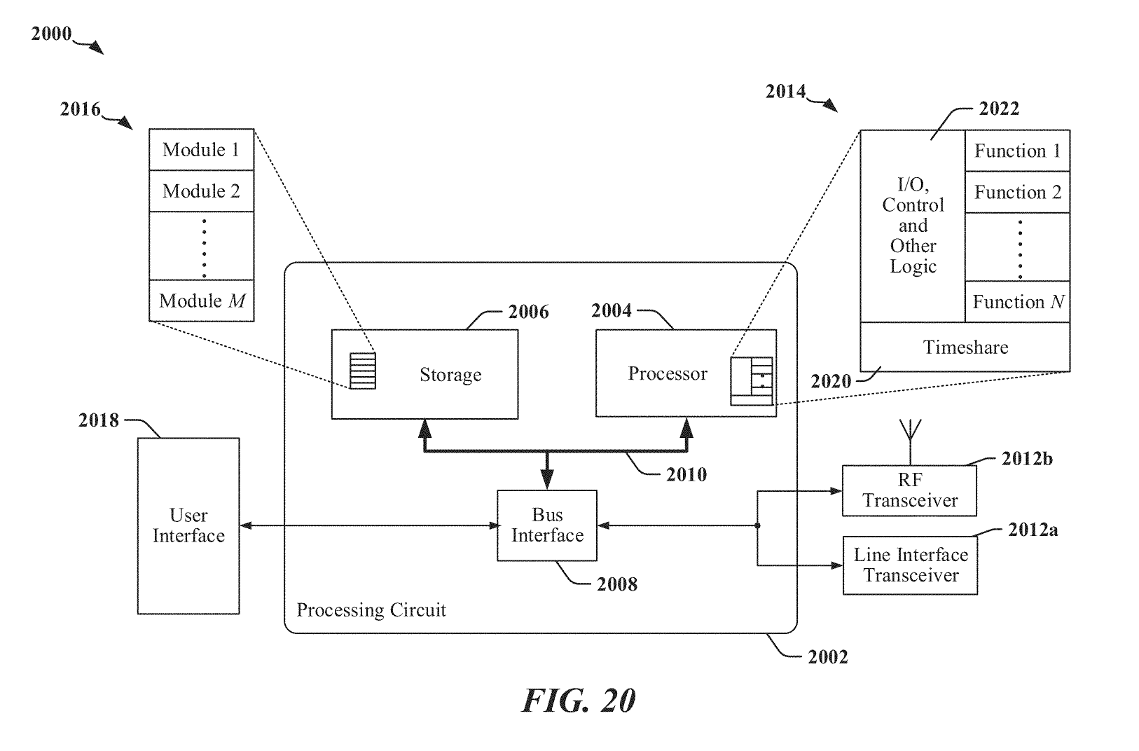

FIG. 20 is a diagram illustrating an example of a hardware implementation for an apparatus 2000. In some examples, the apparatus 2000 may perform one or more functions disclosed herein. In accordance with various aspects of the disclosure, an element, or any portion of an element, or any combination of elements as disclosed herein may be implemented using a processing circuit 2002. The processing circuit 2002 may include one or more processors 2004 that are controlled by some combination of hardware and software modules. Examples of processors 2004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2004 may include specialized processors that perform specific functions, and that may be configured, augmented or controlled by one of the software modules 2016. The one or more processors 2004 may be configured through a combination of software modules 2016 loaded during initialization, and further configured by loading or unloading one or more software modules 2016 during operation.

In the illustrated example, the processing circuit 2002 may be implemented with a bus architecture, represented generally by the bus 2010. The bus 2010 may include any number of interconnecting buses and bridges depending on the specific application of the processing circuit 2002 and the overall design constraints. The bus 2010 links together various circuits including the one or more processors 2004, and storage 2006. Storage 2006 may include memory devices and mass storage devices, and may be referred to herein as computer-readable media and/or processor-readable media. The bus 2010 may also link various other circuits such as timing sources, timers, peripherals, voltage regulators, and power management circuits. A bus interface 2008 may provide an interface between the bus 2010 and one or more transceivers 2012a, 2012b. A transceiver 2012a, 2012b may be provided for each networking technology supported by the processing circuit. In some instances, multiple networking technologies may share some or all of the circuitry or processing modules found in a transceiver 2012a, 2012b. Each transceiver 2012a, 2012b provides a means for communicating with various other apparatus over a transmission medium. In one example, a transceiver 2012a may be used to couple the apparatus 2000 to a multi-wire bus. In another example, a transceiver 2012b may be used to connect the apparatus 2000 to a radio access network. Depending upon the nature of the apparatus 2000, a user interface 2018 (e.g., keypad, display, speaker, microphone, joystick) may also be provided, and may be communicatively coupled to the bus 2010 directly or through the bus interface 2008.

A processor 2004 may be responsible for managing the bus 2010 and for general processing that may include the execution of software stored in a computer-readable medium that may include the storage 2006. In this respect, the processing circuit 2002, including the processor 2004, may be used to implement any of the methods, functions and techniques disclosed herein. The storage 2006 may be used for storing data that is manipulated by the processor 2004 when executing software, and the software may be configured to implement any one of the methods disclosed herein.

One or more processors 2004 in the processing circuit 2002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2006 or in an external computer-readable medium. The external computer-readable medium and/or storage 2006 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2006 may also include, by way of example, a carrier wave, a transmission line, and any other suitable medium for transmitting software and/or instructions that may be accessed and read by a computer. Computer-readable medium and/or the storage 2006 may reside in the processing circuit 2002, in the processor 2004, external to the processing circuit 2002, or be distributed across multiple entities including the processing circuit 2002. The computer-readable medium and/or storage 2006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2006 may maintain software maintained and/or organized in loadable code segments, modules, applications, programs, etc., which may be referred to herein as software modules 2016. Each of the software modules 2016 may include instructions and data that, when installed or loaded on the processing circuit 2002 and executed by the one or more processors 2004, contribute to a run-time image 2014 that controls the operation of the one or more processors 2004. When executed, certain instructions may cause the processing circuit 2002 to perform functions in accordance with certain methods, algorithms and processes described herein.

Some of the software modules 2016 may be loaded during initialization of the processing circuit 2002, and these software modules 2016 may configure the processing circuit 2002 to enable performance of the various functions disclosed herein. For example, some software modules 2016 may configure internal devices and/or logic circuits 2022 of the processor 2004, and may manage access to external devices such as a transceiver 2012a, 2012b, the bus interface 2008, the user interface 2018, timers, mathematical coprocessors, and so on. The software modules 2016 may include a control program and/or an operating system that interacts with interrupt handlers and device drivers, and that controls access to various resources provided by the processing circuit 2002. The resources may include memory, processing time, access to a transceiver 2012a, 2012b, the user interface 2018, and so on.

One or more processors 2004 of the processing circuit 2002 may be multifunctional, whereby some of the software modules 2016 are loaded and configured to perform different functions or different instances of the same function. The one or more processors 2004 may additionally be adapted to manage background tasks initiated in response to inputs from the user interface 2018, a transceiver 2012a, 2012b, and device drivers, for example. To support the performance of multiple functions, the one or more processors 2004 may be configured to provide a multitasking environment, whereby each of a plurality of functions is implemented as a set of tasks serviced by the one or more processors 2004 as needed or desired. In one example, the multitasking environment may be implemented using a timesharing program 2020 that passes control of a processor 2004 between different tasks, whereby each task returns control of the one or more processors 2004 to the timesharing program 2020 upon completion of any outstanding operations and/or in response to an input such as an interrupt. When a task has control of the one or more processors 2004, the processing circuit is effectively specialized for the purposes addressed by the function associated with the controlling task. The timesharing program 2020 may include an operating system, a main loop that transfers control on a round-robin basis, a function that allocates control of the one or more processors 2004 in accordance with a prioritization of the functions, and/or an interrupt driven main loop that responds to external events by providing control of the one or more processors 2004 to a handling function.

Methods for optimizing virtual GPIO latency may include an act of parsing various input sources including sources of GPIO signal state, parameters and/or messages to be transmitted. The input sources may include hardware events, configuration data, mask parameters, and register addresses. Packet-specific latency estimators may be employed to estimate the latency for corresponding packet types based upon the parsed parameters. A packet type to be used for transmission may be selected based on the minimum latency calculated or determined for available packet types. The selected packet type may be identified using a command code, which may be provided to a packetizer with a payload to be transmitted. The command code may also reflect a protocol to be used to transmit the payload. In some implementations, the physical link used to transmit the payload may be operated according to different protocols or different variants of one or more protocols. The protocol to be used for transmitting the payload may be selected based on latencies associated with the various available protocols or variants of protocols.

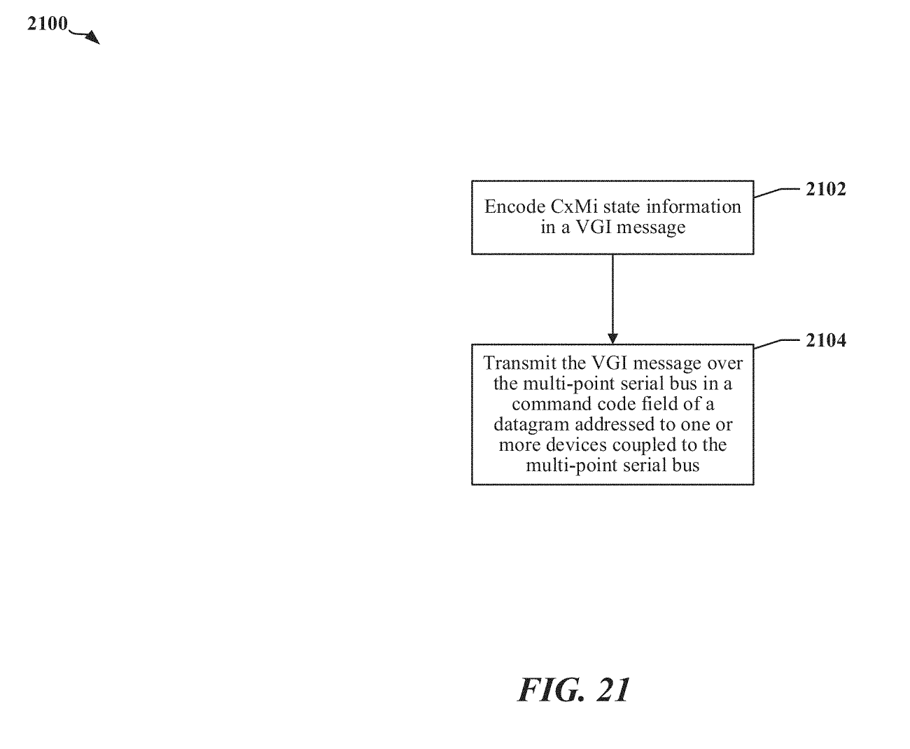

FIG. 21 is a flowchart 2100 of a method for communicating CxMi information over a multi-point serial bus. The method may be performed by a transmitting device coupled to a serial bus. The serial bus may operate in accordance with a multi-point protocol. The serial bus may be operated in accordance with an RFFE, SPMI or other protocol. At block 2102, the transmitting device may encode CxMi state information in a VGI message. At block 2104, the transmitting device may transmit the VGI message over the multi-point serial bus in a command code field of a datagram addressed to one or more other devices coupled to the multi-point serial bus. The transmitting device may format the CxMi state information as a WCI-2 message in the VGI message.

The multi-point serial bus may be operated in accordance with an RFFE protocol or an SPMI protocol. The one or more other devices may maintain at least one register that is configured to cause a bus interface of the one or more other devices to identify that the command code field carries the VGI message. The transmitting device may configure a first bit of the command code field to have a value indicating that the command code field carries a Register 0 write command.

In some implementations, the transmitting device may increase the size of the command code field. One or more additional bits added to the command code field may be used to carry a portion of the VGI message. In some instances, at least one of the other devices maintains a configuration register that includes the size of the command code field and that enables or disables processing of the command code field as a VGI message by the other device. The transmitting device may address the datagram to a magic address configured to identify that the datagram carries a VGI message. In some examples, each of the other devices maintains a configuration register that identifies the magic address and that enables or disables processing of the command code field as a VGI message by the other device. The magic address may be transmitted in a slave address field of the datagram in accordance with an SPMI or RFFE protocol.

In certain examples, the one or more other devices can identify a sending slave address (e.g., of the transmitting device) by capturing the sending slave address of the slave device that wins an arbitration process.

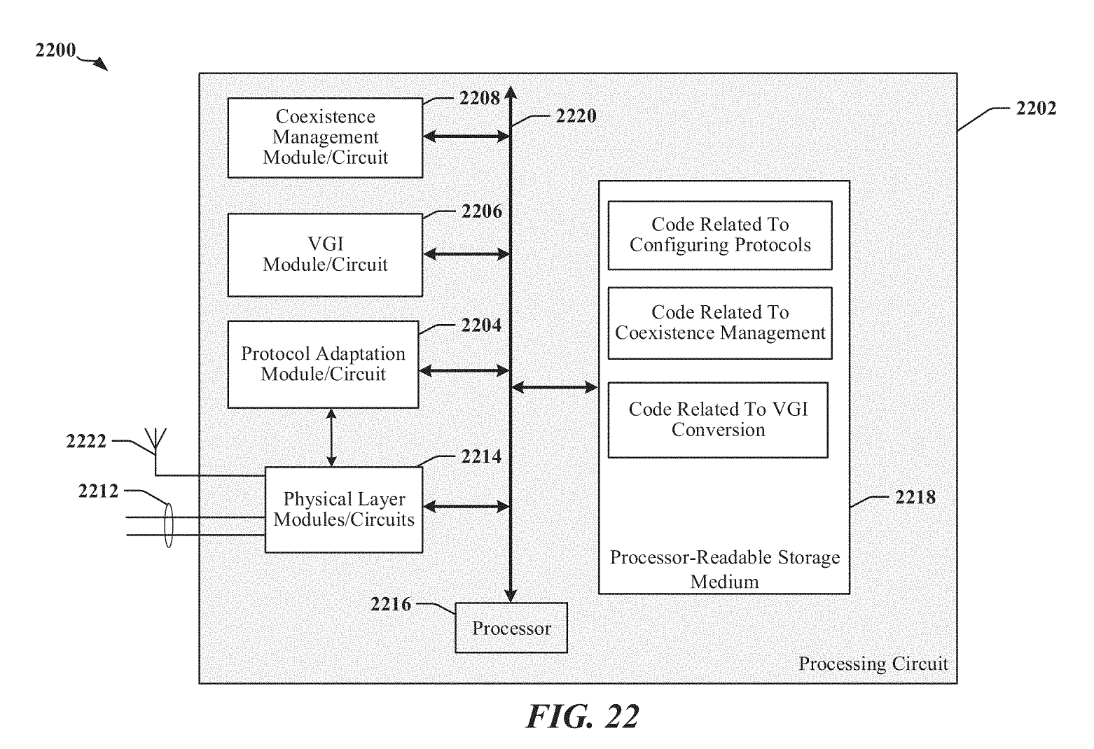

FIG. 22 is a diagram illustrating a simplified example of a hardware implementation for an apparatus 2200 employing a processing circuit 2202. The processing circuit typically has a controller or processor 2216 that may include one or more microprocessors, microcontrollers, digital signal processors, sequencers and/or state machines. The processing circuit 2202 may be implemented with a bus architecture, represented generally by the bus 2220. The bus 2220 may include any number of interconnecting buses and bridges depending on the specific application of the processing circuit 2202 and the overall design constraints. The bus 2220 links together various circuits including one or more processors and/or hardware modules, represented by the controller or processor 2216, the modules or circuits 2204, 2206 and 2208, and the processor-readable storage medium 2218. One or more physical layer circuits and/or modules 2214 may be provided to support communications over a communication link implemented using a multi-wire bus 2212, through an antenna 2222 (to a radio access network for example), and so on. The bus 2220 may also link various other circuits such as timing sources, peripherals, voltage regulators, and power management circuits, which are well known in the art, and therefore, will not be described any further.

The processor 2216 is responsible for general processing, including the execution of software, code and/or instructions stored on the processor-readable storage medium 2218. The processor-readable storage medium may include a non-transitory storage medium. The software, when executed by the processor 2216, causes the processing circuit 2202 to perform the various functions described supra for any particular apparatus. The processor-readable storage medium may be used for storing data that is manipulated by the processor 2216 when executing software. The processing circuit 2202 further includes at least one of the modules 2204, 2206 and 2208. The modules 2204, 2206 and 2208 may be software modules running in the processor 2216, resident/stored in the processor-readable storage medium 2218, one or more hardware modules coupled to the processor 2216, or some combination thereof. The modules 2204, 2206 and 2208 may include microcontroller instructions, state machine configuration parameters, or some combination thereof.

In one configuration, the apparatus 2200 includes modules and/or circuits 2208 adapted to generate CxMi messages, modules and/or circuits 2206 adapted to encode the CxMi messages in VGI messages, and modules and/or circuits 2204 adapted to configure command codes and other datagram fields in SPMI or RFFE protocols.

In some implementations, the apparatus 2200 includes a bus interface including physical layer circuits and/or modules 2214 configured to couple the apparatus to a multi-point serial bus, and a processor 2216. The apparatus 2200 may include a coexistence management module or circuit that generates CxMi messages, where the CxMi message is transmitted in a VGI message through the bus interface in a command code field of a datagram addressed to one or more devices coupled to the multi-point serial bus.

In one example, the processor 2216 is configured to encode CxMi state information in a VGI message, provide the VGI message in a command code field of a datagram addressed to one or more other devices coupled to the multi-point serial bus, and cause the bus interface to transmit the datagram over the multi-point serial bus. The multi-point serial bus may be operated in accordance with an RFFE or SPMI protocol. The one or more other devices may maintain registers configured to cause their respective bus interfaces to identify that the command code field carries the VGI message. The processor 2216 may be configured to configure a first bit of the command code field to have a value indicating that the command code field carries a Register 0 write command. The processor 2216 may be configured to increase the size of the command code field, and may use one or more additional bits added to the command code field to carry a portion of the VGI message. One of the other devices may maintain a configuration register that includes the size of the command code field, and that enables or disables processing of the command code field as a VGI message by the other device.

The processor 2216 may be configured to address the datagram to a magic address configured to identify that the datagram carries a VGI message. Each of the other devices may maintain a configuration register that includes the magic address and that enables or disables processing of the command code field as a VGI message by the other device. The magic address may be transmitted in a slave address field of the datagram in accordance with an SPMI or RFFE protocol. The processor 2216 may be configured to format the CxMi state information as a WCI-2 message in the VGI message.

The processor-readable storage medium 2218 may have one or more instructions which, when executed by at least one processor 2216 or state machine of a processing circuit 2202, cause the processing circuit to encode CxMi state information in a VGI message, and transmit the VGI message over the multi-point serial bus in a command code field of a datagram addressed to one or more devices coupled to the multi-point serial bus. The one or more instructions may further cause the processing circuit 2202 to configure a first bit of the command code field to have a value indicating that the command code field carries a Register 0 write command. The one or more instructions may further cause the processing circuit 2202 to increase the size of the command code field. One or more additional bits added to the command code field may be used to carry a portion of the VGI message. Each of the one or more devices may maintain a configuration register that includes the size of the command code field and that enables or disables processing of the command code field as a VGI message by a corresponding device.

The one or more instructions may further cause the processing circuit 2202 to address the VGI messages to a magic address configured to identify that the datagram carries a VGI message. Each of the one or more devices may maintain a configuration register that includes the magic address and that enables or disables a corresponding device to process the command code field as a VGI message. The magic address may be transmitted in a slave address field of the datagram in accordance with an SPMI or RFFE protocol.

The one or more instructions may further cause the processing circuit 2202 to format the CxMi state information as a WCI-2 message in the VGI message. The one or more instructions may further cause the processing circuit 2202 to address the one or more devices using a slave address field in the datagram, the slave address field preceding the command code field in transmission

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for communicating coexistence management interface (CxMi) information over a multi-point serial bus, comprising:
encoding CxMi state information in a virtual general-purpose input/output (VGI) message; and
transmitting the VGI message over the multi-point serial bus in a command code field of a datagram addressed to one or more devices coupled to the multi-point serial bus.

2. The method of claim 1, wherein the multi-point serial bus is operated in accordance with a radio frequency front-end (RFFE) protocol or a system power management interface (SPMI) protocol.

3. The method of claim 1, wherein the one or more devices maintain at least one register that is configured to cause a bus interface of the one or more devices to identify that the command code field carries the VGI message.

4. The method of claim 1, further comprising:
configuring a first bit of the command code field to have a value indicating that the command code field carries a Register 0 write command.

5. The method of claim 1, further comprising:
increasing size of the command code field, wherein one or more additional bits added to the command code field are used to carry a portion of the VGI message.

6. The method of claim 5, wherein at least one of the one or more devices maintains a configuration register that identifies the size of the command code field and that enables or disables processing of the command code field as a VGI message by a corresponding device.

7. The method of claim 1, further comprising:
addressing the datagram to a magic address configured to identify that the datagram carries a VGI message.

8. The method of claim 7, wherein each of the one or more devices maintains a configuration register that identifies the magic address and that enables or disables processing of the command code field as a VGI message by a corresponding device.

9. The method of claim 7, wherein the magic address is transmitted in a slave address field of the datagram in accordance with an SPMI or RFFE protocol.

10. The method of claim 1, wherein the one or more devices identify a sending slave address by capturing the sending slave address of a slave device that wins an arbitration.

11. The method of claim 1, further comprising:
formatting the CxMi state information as a WCI-2 message in the VGI message.

12. A data communication apparatus comprising:
a bus interface configured to couple the apparatus to a multi-point serial bus; and
a processor configured to:
encode coexistence management interface (CxMi) state information in a virtual general-purpose input/output (VGI) message;
provide the VGI message in a command code field of a datagram addressed to one or more devices coupled to the multi-point serial bus; and
cause the bus interface to transmit the datagram over the multi-point serial bus.

13. The apparatus of claim 12, wherein the multi-point serial bus is operated in accordance with a radio frequency front-end (RFFE) protocol or a system power management interface (SPMI) protocol.

14. The apparatus of claim 12, wherein the one or more devices maintain one or more registers configured to cause a bus interface of the one or more devices to identify that the command code field carries the VGI message.

15. The apparatus of claim 12, wherein the processor is further configured to:
configure a first bit of the command code field to have a value indicating that the command code field carries a Register 0 write command.

16. The apparatus of claim 12, wherein the processor is further configured to:
increase size of the command code field, wherein one or more additional bits added to the command code field are used to carry a portion of the VGI message.

17. The apparatus of claim 16, wherein at least one of the one or more devices maintains a configuration register that identifies the size of the command code field and that enables or disables processing of the command code field as a VGI message by a corresponding device.

18. The apparatus of claim 12, wherein the processor is further configured to:
address the datagram to a magic address configured to identify that the datagram carries a VGI message.

19. The apparatus of claim 18, wherein each of the one or more devices maintains a configuration register that includes the magic address and that enables or disables processing of the command code field as a VGI message by a corresponding device.

20. The apparatus of claim 18, wherein the magic address is transmitted in a slave address field of the datagram in accordance with an SPMI or RFFE protocol.

21. The apparatus of claim 12, wherein the processor is further configured to:
format the CxMi state information as a WCI-2 message in the VGI message.

22. A processor-readable storage medium having one or more instructions which, when executed by at least one processor or state machine of a processing circuit, cause the processing circuit to:
encode CxMi state information in a virtual general-purpose input/output (VGI) message; and
transmit the VGI message over a multi-point serial bus in a command code field of a datagram addressed to one or more devices coupled to the multi-point serial bus.

23. The processor-readable storage medium of claim 22, wherein the one or more instructions further cause the processing circuit to:
configure a first bit of the command code field to have a value indicating that the command code field carries a Register 0 write command.

24. The processor-readable storage medium of claim 22, wherein the one or more instructions further cause the processing circuit to:
increase size of the command code field, wherein one or more additional bits added to the command code field are used to carry a portion of the VGI message.

25. The processor-readable storage medium of claim 24, wherein at least one of the one or more devices maintains a configuration register that identifies the size of the command code field and that enables or disables processing of the command code field as a VGI message by a corresponding device.

26. The processor-readable storage medium of claim 22, wherein the one or more instructions further cause the processing circuit to:
address the datagram to a magic address configured to identify that the datagram carries a VGI message.

27. The processor-readable storage medium of claim 26, wherein each of the one or more devices maintains a configuration register that includes the magic address and that enables or disables a corresponding device to process the command code field as a VGI message, and wherein the magic address is transmitted in a slave address field of the datagram in accordance with an SPMI or RFFE protocol.

28. The processor-readable storage medium of claim 22, wherein the one or more instructions further cause the processing circuit to:
format the CxMi state information as a WCI-2 message in the VGI message.

29. The processor-readable storage medium of claim 22, wherein the one or more instructions further cause the processing circuit to:
address the one or more devices using a slave address field in the datagram, the slave address field preceding the command code field in transmission.

30. An apparatus operable for communicating coexistence management interface (CxMi) information over a multi-point serial bus, comprising:
means for encoding CxMi state information in a virtual general-purpose input/output (VGI) message; and
means for transmitting the VGI message over the multi-point serial bus in a command code field of a datagram addressed to one or more devices coupled to the multi-point serial bus.
